(19) United States
(12) Patent Application Publication
(10) Pub. No.: US 2017/0279867 A1
(43) Pub. Date: Sep. 28, 2017

(54) FRAME DEVICES FOR A SOCIALLY NETWORKED ARTWORK ECOSYSTEM

(71) Applicant: Cameron Morton, Pleasanton, CA (US)

(72) Inventor: Cameron Morton, Pleasanton, CA (US)

(21) Appl. No.: 15/465,391

(22) Filed: Mar. 21, 2017

Related U.S. Application Data
(60) Provisional application No. 62/311,758, filed on Mar. 22, 2016.

(51) Int. Cl. H04L 29/06; H04W 4/20

(52) U.S. Cl. CPC H04L 65/601; H04W 4/206

(57) ABSTRACT

The present disclosure describes methods, systems, and computer program products for a using one or more customized electronic devices to enable connection with an artwork ecosystem and social network so that content can be customized, delivered, and displayed to a user so as to maximize the user experience. A frame device receives, from a central server, media content item data, and determines whether the user preferences stored at the frame device allow a media content item associated with the received media content item to be presented. The frame device converts the received media content item data from a first data format to a second data format. The first data format is associated with the central server and the second data format is associated with the display at the frame device. The frame device presents, on a display, the media content item associated with the received media content item data.

### PRIORITY

This application claims the benefit of U.S. Provisional Application Ser. No. 62/311,758, filed Mar. 22, 2016, which application is incorporated by reference herein its entirety.

### TECHNICAL FIELD

The disclosed implementations relate generally to the field of media content management, and in particular to an electronic device for enabling display of images as part of a social networked artwork ecosystem.

### BACKGROUND

The rise of the computer age has resulted in the ability to convert media into a digital form. Once converted into digital form, users can share, copy, and transfer digital media more cheaply and conveniently than ever. This change has disrupted established methods for managing and distributing media content. For example, digital music is cheap and easy to store and copy.

Traditional media companies have struggled to respond to the changing landscape. As a result, new companies and services have begun to fill the needs and desires of consumers not met by traditional companies. For example, iTunes has had great success by allowing customers to buy and organize their digital media collections over the Internet. This music is then accessible to the user to enjoy when and where the user wishes. Services such as iTunes have only increased consumer desire for easier and more flexible ways to enjoy and share their media collections.

As services provided through electronic devices and over computer networks have increased in scope and reach, many service providers rely on genetic hardware provided by third parties. However, often times, specific hardware customized for an intended purpose or service can provide a better user experience.

### DESCRIPTION OF THE DRAWINGS

Some implementations are illustrated by way of example and not limitation in the FIGS. of the accompanying drawings, in which:

FIG. 1 is a network diagram depicting a client-server system that includes various functional components of a frame device and a central server, in accordance with some implementations.

FIG. 2 is a block diagram illustrating a frame device, in accordance with some implementations.

FIG. 3 is a block diagram illustrating a central server.

FIGS. 4A-4D illustrate an exemplary user interface for a user interface of a frame device in a complete media ecosystem in which media content items (e.g., images, art, video, etc. are easily accessible to a user through a variety of areas and platforms as well as a search feature and a social feature.

FIGS. 5A-5E illustrate an exemplary user interface for a user interface of a frame device for organizing and selecting media content items in a complete media ecosystem in which media content items (e.g., images, art, video, etc.) are accessible.

FIG. 6 is a flow diagram illustrating a method, in accordance with some example embodiments, for receiving and presenting data through frame devices integrated with a socially networked artwork ecosystem.

FIG. 7 is a flow diagram illustrating a method, in accordance with some example embodiments, for displaying a collection over a plurality of frame devices.

FIG. 8A is a flow diagram illustrating a method, in accordance with some example embodiments, for using a dedicated frame device to receive and present media content items from a media content service with a social networking component.

FIG. 8B is a flow diagram illustrating a method, in accordance with some example embodiments, for using a dedicated frame device to receive and present media content items from a media content service with a social networking component.

FIG. 9 is a block diagram illustrating an architecture of software, in accordance with an example embodiment.

FIG. 10 is a block diagram illustrating components of a machine 1000, according to some example embodiments, able to read instructions from a machine-readable medium (e.g., a machine-readable storage medium) and perform any one or more of the methodologies discussed herein.

Like reference numerals refer to corresponding parts throughout the drawings.

### DETAILED DESCRIPTION

The present disclosure describes methods, systems, and computer program products for a using one or more customized electronic devices to enable connection with an artwork ecosystem and social network so that content can be customized, delivered, and displayed to a user so as to maximize the user experience. In the following description, for purposes of explanation, numerous specific details are set forth in order to provide a thorough understanding of the various aspects of different implementations. It will be evident, however, to one skilled in the art, that implementations can be practiced without all of the specific details and/or with variations permutations and combinations of the various features and elements described herein.

The algorithmic processes used to manage a frame device and control its interacting with a media ecosystem are implemented with a combination of hardware (e.g., computer processors and memory) and software (e.g., executable instructions) that is generally referred to herein as an item. Furthermore, the example embodiments that are presented herein are generally applicable to a wide variety and nature of applications and tasks.

In some example embodiments, a frame device receives media content data from a central server (e.g., a server associated with a media content ecosystem). In some example embodiments, the media content data is data that describes a media content item and how it should be displayed on a frame device. In some example embodiments, each frame device includes a display that is capable of displaying one or more types of media content item.

In some example embodiments, the received media content data delivered to a frame device is in response to a specific request. For example, a user associated with a frame device sends a request (e.g., from the frame device itself or from another device) to the central server for a specific media content item, and the central server responds by sending the data associated with the requested media content item to the indicated frame device.

In some example embodiments, the received media content data is sent to the frame device based on a request from a user that is not associated with the frame device (e.g., another user of the media content ecosystem that tries to send a media content item to the frame device). In response, the frame device determines whether the user that originated the request is authorized to change the displayed content item (or initiate display of content item). In some example embodiments, permissions for a specific user are determined by the user associated with the frame device (e.g., the owner or the user who is logged into the frame device).

In some example embodiments, the frame device has social network data for the user associated with the frame device. For example, the frame device includes data listing a plurality of users who are connected to the user through a social network (e.g., users who are noted as “friends” or “contacts”). The frame device can then determine whether the user that indicated the content item data transfer is among the list of social network contacts and determine whether to allow the content item data to be displayed based on the closeness of the social connection.

In some example embodiments, the frame device converts the content item data received from the central server from a format associated with the central server to a format associated with the frame device. In this way, the central server can store all content items in a single format and then have each frame device convert it to the format needed by the frame device.

In some example embodiments, the frame device then displays (or otherwise presents) the media content item. In some example embodiments, the frame device determines that the content item data is from a user who does not have permission to initiate display of media content items on the frame device and then the media content item represented by the frame device is not displayed.

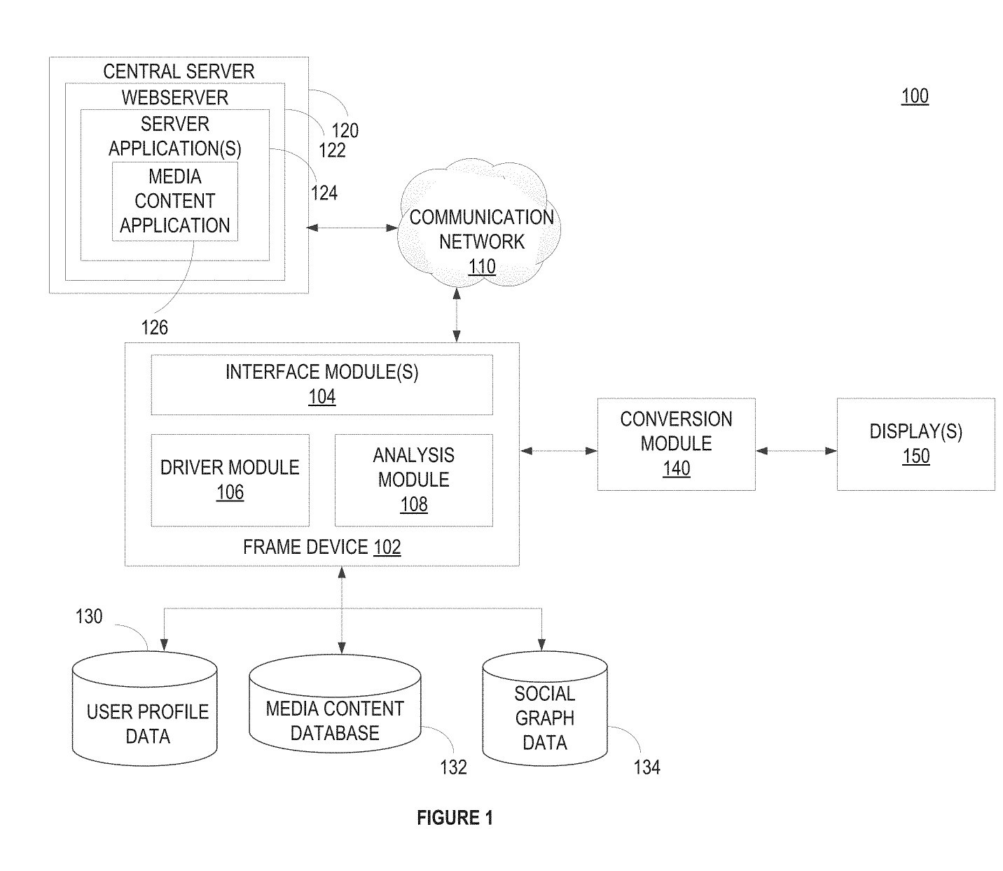

FIG. 1 is a network diagram depicting a client-server system 100 that includes various functional components of a frame device 102 and a central server 120, in accordance with some implementations. The client-server system 100 includes one or more frame devices 102 and a central server 120. One or more communication networks 110 interconnect these components. The communication network 110 may be any of a variety of network types, including local area networks (LAN), wide area networks (WAN), wireless networks, wired networks, the Internet, personal area networks (PAN), or a combination of such networks.

In some implementations a frame device comprises a customized electronic device including a processor, memory, a display (e.g., using a display technology such as E-paper or LED), and one or more input devices including but not limited to a keyboard, keys or buttons, a touch screen, a microphone for voice input, and so on. In further embodiments, the frame device 102 may comprise one or more of a touch screen, accelerometer, gyroscope, camera, microphone, global positioning system (GPS) device, and so forth.

In some example embodiments, the frame device 102 is a device specifically customized (both customized hardware and firmware) to interact with a central server 120 associated with a particular media content item ecosystem and social network.

In some example embodiments, each frame device 102 includes one or more applications or modules to enable it to perform the functions assigned to it. In some example embodiments, the frame device includes an interface module 104. In some example embodiments, the interface module 104 enables the frame device to receive input from users (e.g., via an input device such as a touch screen) and from a central server 120 over a communication network 110.

In some implementations, as shown in FIG. 1, the frame device 102 is generally based on a three-tiered architecture, consisting of an interface layer, application logic layer, and data layer. As is understood by skilled artisans in the relevant computer and Internet-related arts, each module or engine shown in FIG. 1 represents a set of executable software instructions and the corresponding hardware (e.g., memory and processor) for executing the instructions. To avoid unnecessary detail, various functional modules and engines that are not germane to conveying an understanding have been omitted from FIG. 1. However, a skilled artisan will readily recognize that various additional functional modules and engines may be used with a frame device, such as that illustrated in FIG. 1, to facilitate additional functionality that is not specifically described herein. Furthermore, the various functional modules and engines depicted in FIG. 1 may reside on a single server computer, or may be distributed across several server computers in various arrangements. Moreover, although depicted in FIG. 1 as a three-tiered architecture, other configurations or architecture may be used for the herein described implementations.

As shown in FIG. 1, the interface module 104 allows input from and communication to one or more users (e.g., through a touch interface) or other computer devices over a LAN or the communication network 110. In some example embodiments, the interface module 104 sends requests to the server system (e.g., central server 120 in FIG. 1) or receives data from the server system (e.g., central server 120 in FIG. 1) over a communication network 110.

In other example embodiments, the frame device 102 is one of a plurality of frame devices in a LAN and uses the interface module 104 to communicate, coordinate, send instructions, and receive instructions from other frame devices. In some example embodiments, a plurality of frame devices 102 receive instructions from another computing device (e.g., locally based personal computer system) which is operated by a user (e.g., the owner of the location and the frame devices) to control and co-ordinate the plurality of frame devices through the interface module 104.

In some example embodiments, interface modules) 104 receives requests in the form of Hypertext Transport Protocol (HTTP) requests, or other web-based, application programming interface (API) requests.

As shown in FIG. 1, the data layer includes several databases, including databases for storing data for various entities of the frame device 102, including user profile data 130, a media content database 132 (e.g., a database that includes media content data received from the central server 120, and social graph data 134 (e.g., data concerning users relationships to each other). In some implementations the social graph data 134 includes a graph database, which is a particular type of database that uses graph structures with nodes, edges, and properties to represent and store data. Of course, with various alternative implementations, any number of other entities might be included in the social graph (e.g., companies, organizations, schools and universities, religious groups, and any other group), and as such, various other databases may be used to store data corresponding with other entities.

In some example embodiments, a user of the central server 120 is able to invite other users, or be invited by other users, to connect via the central server 120. A “connection” may require a bi-lateral agreement by the users, such that both users acknowledge the establishment of the connection. Similarly, with some implementations, a user may elect to “follow” or “friend” another user. In contrast to establishing a “connection,” the concept of “following” another user typically is a unilateral operation, and at least with some implementations, does not require acknowledgement or approval by the user that is being followed. When one user follows another, the user who is following may receive automatic notifications about various activities undertaken by the user being followed. In addition to following another user, a user may elect to follow a company, a topic, an artist, a conversation, or some other entity, which may or may not be included in the social graph.

With some implementations, users may subscribe to or join groups affiliated with one or more companies, galleries, museums, and so on. For instance, with some implementations, users of the media management central server 120 indicate an affiliation with a gallery to which they have a membership. Media content item (e.g., art) changes or updates associated with that gallery can then be automatically communicated to the users. With some implementations, users subscribe to receive information concerning particular companies, galleries, or museums.

In some implementations the application logic layer includes various application modules, which, in conjunction with the interface module 122, generate various user interfaces (e.g., web pages) with data retrieved from various data sources in the data layer. With some implementations, application modules are used to implement the functionality associated with various applications, services, and features of the frame device 102. Of course, applications or services that utilize a driver module 106 and an analysis module 108 may be separately implemented in their own application modules.

In addition to the various application modules, the application logic layer includes the driver module 106 and the analysis module 108. As illustrated in FIG. 1, with some implementations, the driver module 106 and the analysis module 108 are implemented as services that operate in conjunction with various application modules. For instance, any number of individual application server modules can invoke the functionality of the driver module 106 and the analysis module 108, to include an application module associated with a messaging application and/or an application module associated with an application to facilitate the viewing of a user interface of the frame device 102. However, with various alternative implementations, the driver module 106 and the analysis module 108 are implemented as distinct application modules such that they operate as stand-alone applications. With some implementations, the driver module 106 and the analysis module 108 include or have an associated publicly available API that enables third-party applications to invoke the functionality of the driver module 106 and the analysis module 108.

In some example embodiments, the driver module 106 uses stored data about the data format associated with the server system (e.g., central server 120 in FIG. 1), the data format associated with the frame device 102, and the specifications and control scheme of the frame device 102 to convert content item data received from the server system and display it on a display associated with the frame device 102.

In some example embodiments, the frame device 102 alters or customizes the received content item data to the specifications of the frame device 102. For example, if an image is a lower resolution (e.g., pixel density) than the frame device 102 supports, the driver module 106 algorithmically increases the resolution of the image to match that of the display associated with the frame device 102.

In some example embodiments, the analysis module 108 determines, for received content item data, whether the associated content item should be presented at the frame device (e.g., device 102 in FIG. 1). In some example embodiments, the analysis module 108 analyzes content included with the item content data (e.g., metadata describing the content item, its source, information about the specifications of the content item, and so on). In some example embodiments, the analysis module 108 uses the data associated with the content item data to determine whether the content item should be displayed.

In some example embodiments, the frame device 102 includes user preference data, wherein the preference data includes explicit user preferences on what type of content item is allowed to be displayed, when content items are allowed to be displayed, and which users of the central server 120 can update the displayed content item.

In some example embodiments, the user preferences allow users to change or update the content item based on whether a user is connected to the owner of the frame device 102 in a social network associated with the central server 120. For example, the content item data includes metadata identifying user A as the source of the content item data (e.g., user A caused the content item to be sent to the frame device 102). The analysis module 108 determines whether user A is connected to user B (e.g., the owner of frame device 102). In some example embodiments, the analysis module 108 will determine that user A and user B are connected (e.g., are friends) over the social network associated with the central server 120. The analysis module 108 determines whether the frame device is currently available for a media content item change. In accordance with a determination that both users are connected in the social network and the frame device 102 is available to be changed, the analysis module 108 then instructs the driver module 106 to update the displayed media content item.

In some example embodiments, the frame device includes a conversion module 140. In some example embodiments, the conversion module 140 allows media content item data to be converted from a first format (e.g., a format associated with the central server 120) to a second format (e.g., a format associated with the displays 150).

In some example embodiments, the display 150 are associated with or integrated with the frame device 102 and displays media content items received by the frame device 120. In some example embodiments, the frame device is one of e-paper displays, LCD displays, plasma displays, LED displays, and so on.

In some example embodiments, a central server 120 communicates with the frame device 102 over the communication network 110. In some example embodiments, the central server is a media content server system. In some example embodiments, the cental server 120 includes a webserver 122 that facilitates communication with the frame device.

In some example embodiments, the webserver 122 includes one or more server applications 124. In some example embodiments, the one of the server applications 124 is a media content application 126. In some example embodiments, the media content application transmits media content items to a frame device 102 connected to the central server 120 over the communication network 110.

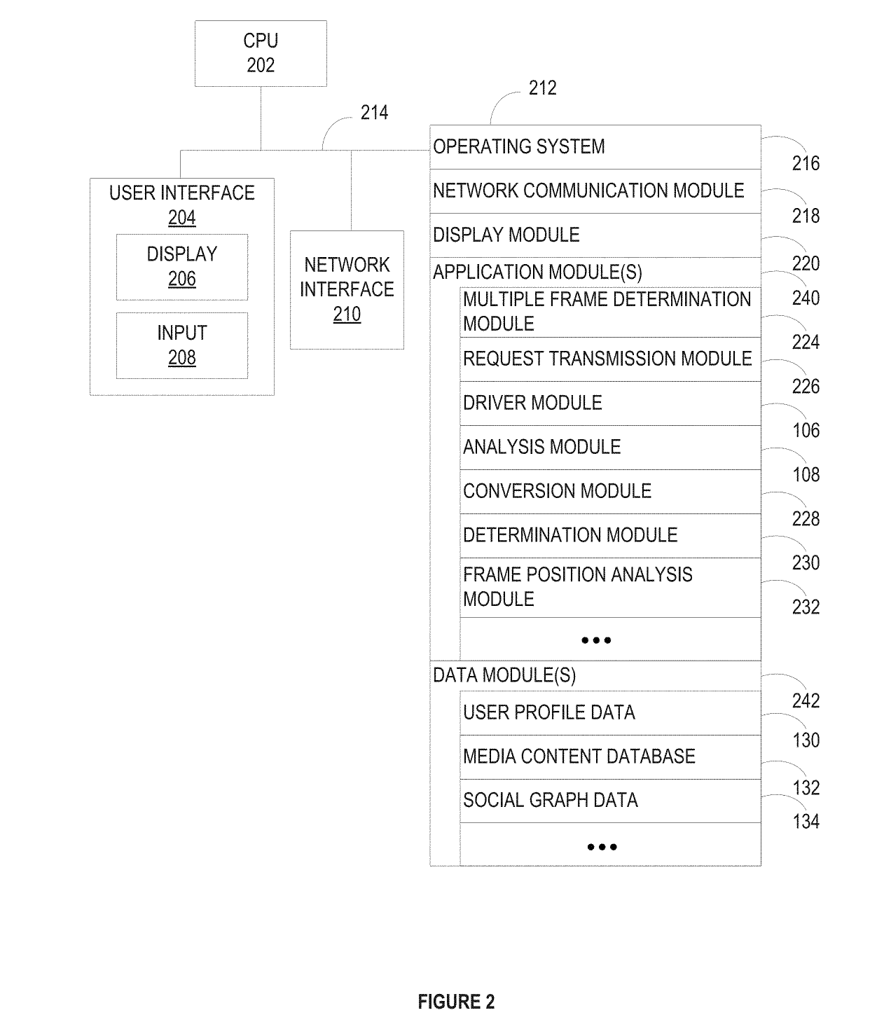

FIG. 2 is a block diagram illustrating a frame device 102, in accordance with some implementations. The frame device 102 typically includes one or more central processing units (CPUs) 202, one or more network interfaces 210, memory 212, and one or more communication buses 214 for interconnecting these components. The frame device 102 includes a user interface 204. The user interface 204 includes a display device 206 and optionally includes an input means such as a keyboard, mouse, a touch sensitive display, or other input buttons 208. Furthermore, some frame devices 102 use a microphone and voice recognition to supplement or replace the keyboard.

Memory 212 includes high-speed random access memory, such as DRAM, SRAM, DDR RAM or other random access solid state memory devices; and may include non-volatile memory, such as one or more magnetic disk storage devices, optical disk storage devices, flash memory devices, or other non-volatile solid state storage devices. Memory 212 may optionally include one or more storage devices remotely located from the CPU(s) 202. Memory 212, or alternately the non-volatile memory device(s) within memory 212, comprises a non-transitory computer readable storage medium.

In some implementations, memory 212 or the computer readable storage medium of memory 212 stores the following programs, modules, and data structures, or a subset thereof:
an operating system 216 that includes procedures for handling various basic system services and for performing hardware dependent tasks;
a network communication module 218 that is used for connecting the frame device (e.g., device 102 in FIG. 1) to other computers via the one or more communication network interfaces 210 (wired or wireless) and one or more communication networks, such as the Internet, other WANs, LANs, MANs, etc.;
a display module 220 for enabling the information generated by the operating system 216 and applications 240 to be presented visually on the display 206;
one or more client application modules 240 for handling various aspects of interacting with the central server 120, including but not limited to:
   a multiple frame determination module 224 for determining whether a given frame device 102 is part of a multiple frame device system that includes a plurality of frame devices 102 with a common owner, in a common location, and connected over a LAN and able to present media content projects that require multiple displays simultaneously presenting media content items (e.g., an art installation that has multiple images intended to be displayed simultaneously;
   a request transmission module 226 for sending requests to display a particular media content item at a particular frame associated with the central server (FIG. 1, 120);
   a driver module 106 for correctly directing a conversion module 228 to convert received media content item data from a first format to a second format and prepare the media content item to be displayed at the frame device 102;
   an analysis module 108 for determining, based on data received from a server system (e.g., central server 120 in FIG. 1) whether to present media content item on the display 206 of frame device 102;
   a conversion module 228 for converting media content item data from a first format (e.g., the format that the central server 120 uses that the data was stored in when received) and a second format (e.g., the format needed to display the media content item data at the display 206 associated with the frame device 102);
   a determination module 230 for evaluating whether a first user and a second user are connected on a social network based on social graph data 134 and, if so, determining how closely the two users are connected (e.g., based on shared connections, profile similarities, and so on); and
   a frame position analysis module 232 for determining, for environments with a plurality of frame devices 102 with the same owner/operator on the same local area network, the size and position of each frame device 102 relative to the others;
a data module 242, for storing data relevant to the frame device, including but not limited to:
   user profile data 130 for storing user profile data related to a user of the frame device 102 including, but not limited to, the user's preferences;
   a media content database 132 for storing data associated with media content items (e.g., videos, images, audio files, and so on) associated with the frame device 102 (e.g., in a local cache); and
   a social graph data 134 including data that represents users of the server system (e.g., central server 120 in FIG. 1) and the social connections between them.

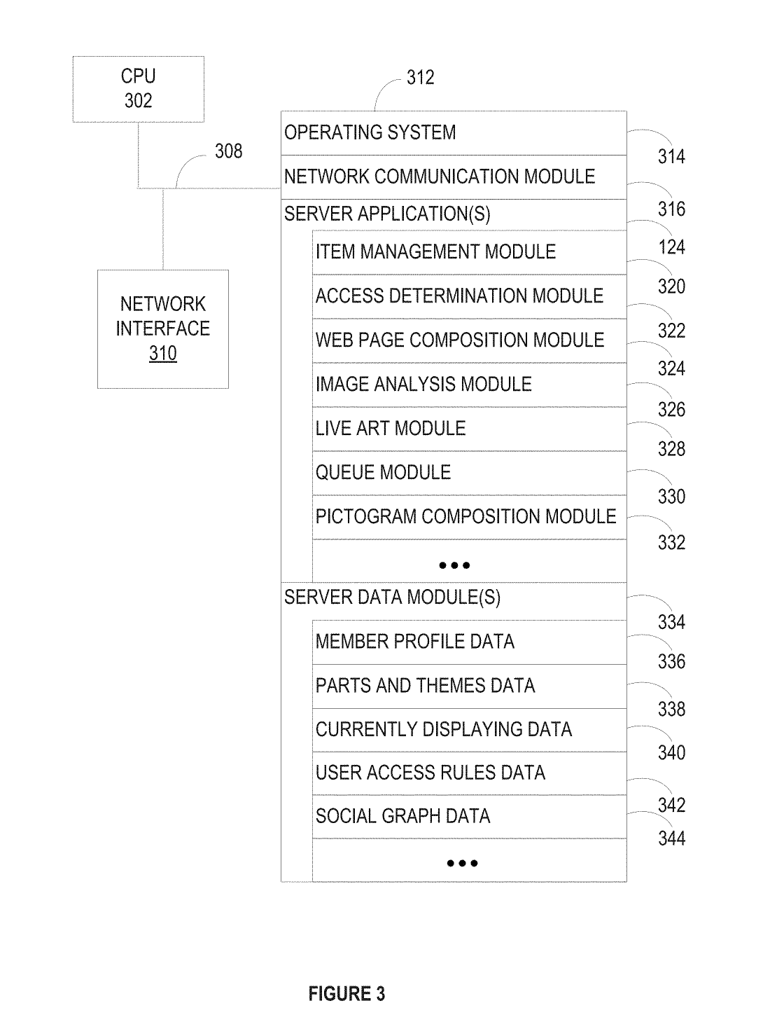

FIG. 3 is a block diagram illustrating a central server (FIG. 1, 120) The media management central server 120 typically includes one or more processing units (CPUs) 302, one or more interfaces 310, memory 312, and one or more communication buses 308 for interconnecting these components. Memory 306 includes high-speed random access memory, such as DRAM, SRAM, DDR RAM other random access solid state memory devices; and may include non-volatile memory, such as one or more magnetic disk storage devices, optical disk storage devices, flash memory devices, or other non-volatile solid state storage devices. Memory 306 may optionally include one or more storage devices remotely located from the CPU(s) 302.

Memory 312, or alternately the non-volatile memory device(s) within memory 312, comprises a non-transitory computer readable storage medium. In some implementations, memory 312 or the computer readable storage medium of memory 312 stores the following programs, modules, and data structures, or a subset thereof:
an operating system 314 that includes procedures for handling various basic system services and for performing hardware dependent tasks;
a network communication module 316 that is used for connecting the media management central server 120 to other computers via the one or more communication network interfaces 310 (wired or wireless) and one or more communication networks, such as the Internet, other WANs, LANs, MANs, and so on;
one or more server application modules 124 for performing the services offered by media management central server 120, including but not limited to:
   an item management module 320 for sending and receiving media content items from and to client systems and display devices (e.g., frames) as needed and presenting information related to organizing a user's media content collection through a website;
   an access determination module 322 for determining, based on user access rules, whether a particular user is authorized to view and/or change media content currently being presented at a particular display device;
   a web page composition module 324 for dynamically creating web pages for users based on the specific user request and the items to which the user has access;
   an image analysis module 326 for analyzing existing images to identify and extract useful components, themes, and templates for later use;
   a live art module 328 for receiving, in real time, actions taken by an artist to create a painting or an image and relaying them, in real time, to a second display device for viewing in real time;
   a queue module 330 for determining, based on a schedule received from a user, whether the media content item presented at a given display device needs to be changed and if so, automatically determining the media content item that should be presented and transmitting the determined item to the appropriate display device; and
   a pictogram composition module 332 for translating a text based message into an informative pictogram using parts and themes data 338 stored at the central server, 120;
server data modules 334, holding data related to the central server (FIG. 1, 120), including but not limited to:
   user profile data 336 including data concerning user demographic information, user interests, user owned media content items, display devices associated with users, user social graph data, user queue information, user location data (e.g., based on GPS data), and any other relevant user data;
   parts and themes data 338 including images, parts of images, templates, and theme data extracted from other media content items;
   currently displaying data 340 including data indicating which media content item is currently displayed at each display device;
   user access rules data 342 including data for each respective display regarding which users, at what times, can change the currently displayed media content item at the display device; and
   social graph data 334 including data that represents users of the server system (e.g., central server 120 in FIG. 1) and the social connections between them.

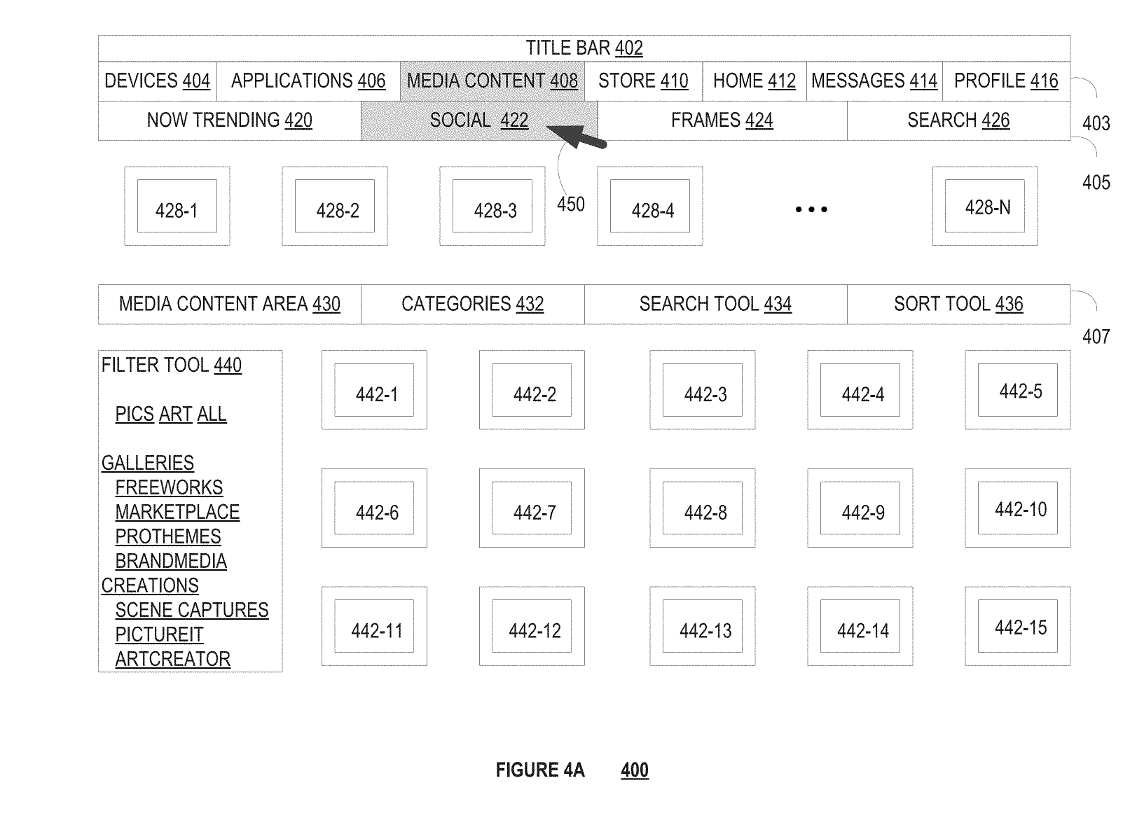

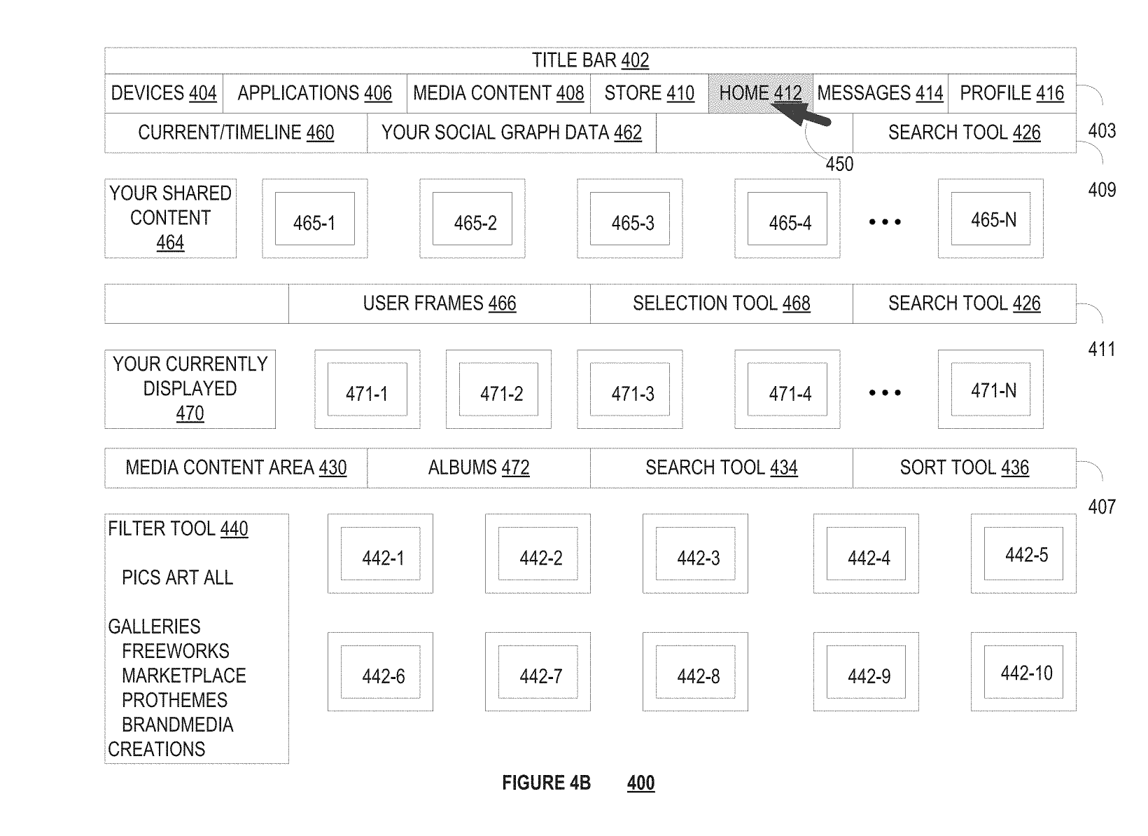

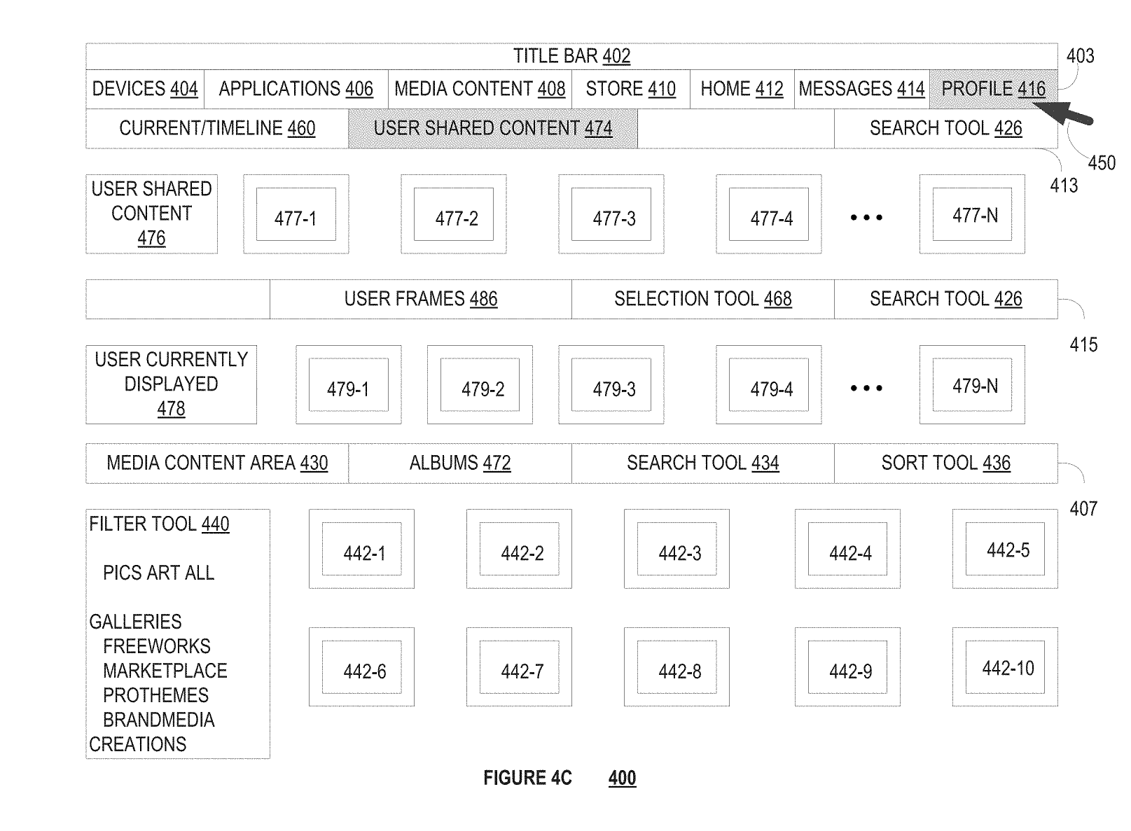

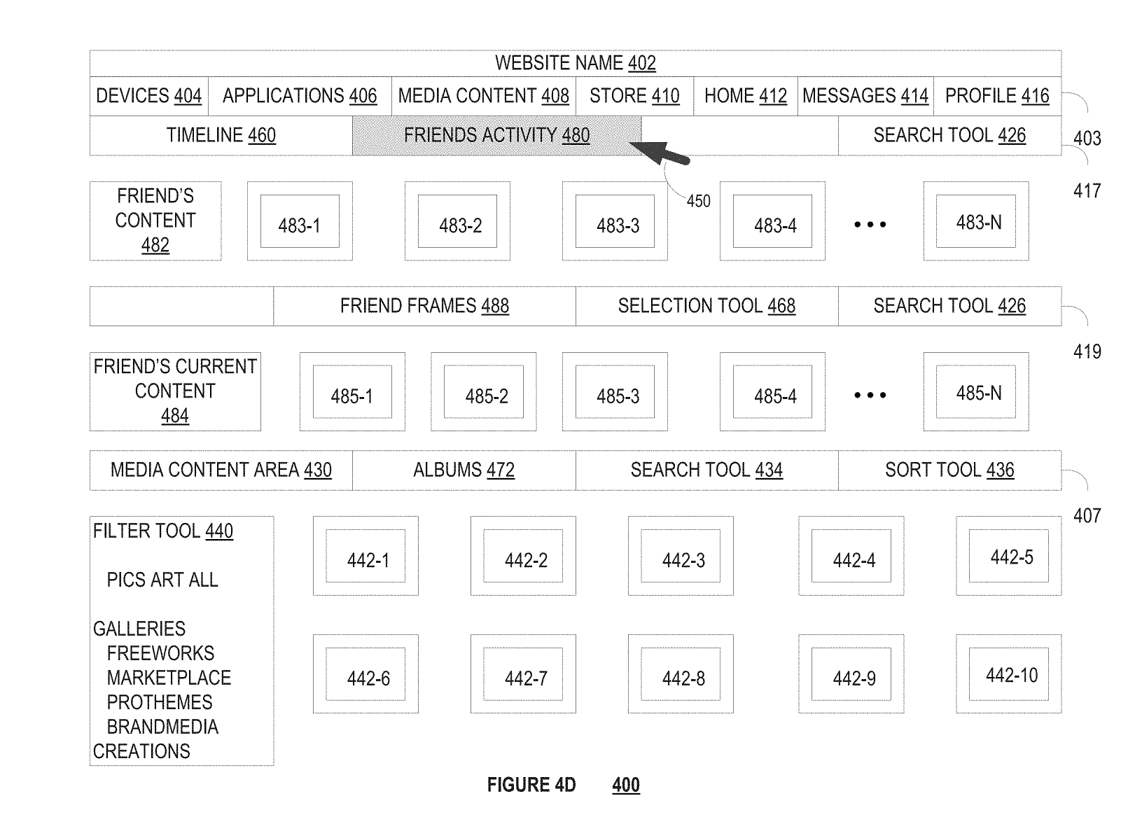

FIG. 4A illustrates an exemplary user interface 400 for a user interface of a frame device in a complete media ecosystem in which media content items (e.g., images, art, video, etc.) are easily accessible to a user through a variety of areas and platforms as well as a search feature and a social feature. In this example, the user interface 400 includes a title bar 402 that displays the name of the media content service (e.g., Jotl or another service name). Below the title bar 402 is the navigation bar 403 that allows a user to quickly navigate from the home page to the currently trending media content items or the profiles of other users. The website navigation bar 403 includes a device selection button 404, an applications section button 406, a media content button 408, a store button 410, a home button 412, a messages 414 button, and a profile button 416.

In some implementations, the media content button 408 is selected (e.g., by the use a touch indication or a pointer 450) by the user of the frame device (e.g., device 102 in FIG. 1). In response, the user interface displays a sub-section navigation bar 405 that includes buttons associated with the media content section. For example, the sub-section navigation bar 405 includes a now trending button 420, a social button 422, a frames button 424, and a search tool button 426. In some example embodiments, selecting the now trending button 420 will display a selection of currently popular media content items in the media content service. In some example embodiments, users can customize the media content items that appear when now trending 420 is selected based on media content item type, source user, content, and so on.

In some example embodiments, the social button 422 is selected and in response, the user interface displays one or more media content items (428-1 to 428-N) from the user's own social circle (e.g., users who are friends of the first user). In some example embodiments, the display content items will be popular media content items from the first user's (e.g., the user who owns the frame device (e.g., device 102 in FIG. 1)) social graph. In other example embodiments, the display media content items are the most recent or most recommended media content items.

In some example embodiments, selecting the frames button 424 results in the user interface displaying the media content that is currently displayed in each of the frames associated with (e.g., owned by or registered to) the first user.

In some example embodiments, the user interface also includes a media content area 430. In some example embodiments, the media content area 430 has a media content navigation bar 407.

In some example embodiments, the media content navigation bar 407 includes a media content area button 430 to allow the user to return to the unfiltered media content area after conducting a search. The media content navigation bar 407 also includes a categories button 432, a search tool button 434, and a sort tool button 436.

In some example embodiments, the categories button 432 includes a drag down menu, such that when a user selects the categories button, a list of categories are displayed for the user to choose from. In some example embodiments, the search tool button 434 has an associated search input field to receive search text from a user. In some example embodiments, the sort tool button 436 includes a drop down such that when a user selects the sort tool button 436 a drop down menu with sorting options is displayed. In some example embodiments, the user selects a sorting option and the displayed media content items are sorted in accordance with the selected sorting option.

In some example embodiments, the media content area 430 also includes one or more media content items (442-1 to 442-15). In some example embodiments, the media content area 430 includes icons or small scale pictures representing particular media content items. In some example embodiments, the media content item also includes a filter tool 440. In some example embodiments, the filter tool 440 includes a plurality of filter criteria (e.g., “Pics,” “Art,” “All,” and so on).

In some example embodiments, each filter criterion includes a link such that when a particular criterion is selected, the displayed media content items (e.g., 422-1 to 442-15) will change to include only media content items that match the selected criterion. In this example embodiment, the filter tool 440 includes different criteria types including criteria describing the type of media content items (e.g., “pics” which is used to select for pictures and “art” which is used to select artistic works such as paintings.). In some example embodiments, media content items are associated with specific criteria.

FIG. 4B illustrates an exemplary user interface 400 for a user interface of a frame device in a complete media ecosystem in which media content items (e.g., images, art, video, etc.) are easily accessible to a user through a variety of areas and platforms as well as a search feature and a social feature. In this example, the user interface 400 includes a title bar 402 that displays the name of the media content service (e.g., Jotl or another service name). Below the title bar 402 is the navigation bar 403 that allows a user to quickly navigate from the home page to the currently trending media content items or the profiles of other users. The website navigation bar 403 includes a device selection button 404, an applications section button 406, a media content button 408, a store button 410, a home button 412, a messages 414 button, and a profile button 416.

In some implementations, the home button 412 is selected by the user of the frame device (e.g., device 102 in FIG. 1). In response, the user interface displays a sub-section navigation bar 409 for the home page. In some example embodiments, the homepage sub-section navigation bar 409 includes buttons associated with the home page of the user that is currently registered with the frame device (e.g., device 102 in FIG. 1). For example, User A buys a frame device (e.g., device 102 in FIG. 1) and uses the user interface of the frame device. When the user selects the home button 412, the user interface displays the home page of User A.

The home page sub-section navigation bar 409 includes a current/timeline 460 button, a “your social graph data” button 462, and a search tool button 426. In some example embodiments, when a user selects the current/timeline button 460, the home page displays a series of images (465-1 to 465-N) associated with media content items that have been recently viewed by the user, shared with the user, or posted to the user by a friend.

In some example embodiments, the user selects the “your social graph data” button 462. In response, the frame device (e.g., device 102 in FIG. 1) displays information about the user's social graph including a list of friends or contacts through the media content server service, images associated with media content items popular in the social group of the user, media content items currently presented in frame devices (e.g., device 102 in FIG. 1) associated with friends (e.g., social contacts) of the user, and so on.

In some example embodiments, the user interface includes a “your shared content” area 464 that includes one or more images associated with media content items (e.g., 465-1 to 465-N) that are currently shared (through the media content service) for other users to view or use.

In some example embodiments, the home page view also includes a user frames section. In some example embodiments, the user frames section includes a frames navigation bar 411. In some example embodiments, the frames navigation bar 411 includes a “user frames” button 466, a selection tool button 468, and a search tool button 426.

In some example embodiments, selection of the “your frames” button 466 results in the frame device (e.g., device 102 in FIG. 1) altering the user interface to display the “your currently displayed” area 470. The “your currently displayed” area 470 includes a series of images (471-1 to 471-N) that each represent a media content item that is currently displayed at a frame device (e.g., device 102 in FIG. 1) owned by the user. Thus, if the user has ten frame devices that currently display media content items (e.g., pictures, videos, images, art, and so on), then the “your currently displayed” area 470 has a maximum of ten images (e.g., one for each frame device).

As with FIG. 4A, the user interface also includes a media content area. In some example embodiments, the media content area has a media content navigation bar 407 that includes a media content area button 430 to allow the user to return to the unfiltered media content area after conducting a search. The media content navigation bar 407 also includes a categories button 432, a search tool button 434, and a sort tool button 436. The media content area includes one or more filter tools 440 and a plurality of images (442-1 to 442-10).

FIG. 4C illustrates an exemplary user interface 400 for a user interface of a frame device in a complete media ecosystem in which media content items (e.g., images, art, video, etc.) are easily accessible to a user through a variety of areas and platforms as well as a search feature and a social feature. In this example, the user interface 400 includes a title bar 402 that displays the name of the media content service (e.g., Jotl or another service name). Below the title bar 402 is the navigation bar 403 that allows a user to quickly navigate from the home page to the currently trending media content items or the profiles of other users. The website navigation bar 403 includes a device selection button 404, an applications section button 406, a media content button 408, a store button 410, a home button 412, a messages 414 button, and a profile button 416.

In some implementations, the profile button 416 is selected by the user of the frame device (e.g., device 102 in FIG. 1). In response, the user interface displays a sub-section navigation bar 413 for the profile page. In some example embodiments, the profile page sub-section navigation bar 411 includes buttons associated with the profile page of the user that is currently registered with the frame device (e.g., device 102 in FIG. 1).

In some example embodiments, a profile page is a page (e.g., a web page) that is publicly available to other users of a service (e.g., the media content service). The profile page includes only the data that the user (e.g., owner of the profile) has chosen to make publicly available. In contrast, the home page is the data that is shown only to the user and may include private data that is not publicly posted.

In some example embodiments, the profile page content is determined based on the relationship of the user seeking to access the profile page and the user who is the owner or subject of the profile page. For example, User A visits the profile page of User B through the user interface of a frame device (e.g., device 102 in FIG. 1). If User A is connected to User B through the social networking service of the media content service (e.g., they are friends), then the profile page of User B may include additional information not available to users who are not socially connected to User B.

The profile page sub-section navigation bar 413 includes a current/timeline 460 button, a user shared content button 474, and a search tool button 426. In some example embodiments, when a user selects the current/timeline button 460, the profile page displays a series of images (477-1 to 477-N) associated with media content items that have been recently made public by the user, shared with the user, or posted to the user by a friend.

In some example embodiments, when a user selects the user shared content button 474 (as shown in FIG. 4C), the frame device (e.g., device 102 in FIG. 1) alters the user interface to display a user shared content are 476. In some example embodiments, the user shared content area 476 includes a series of images (e.g., 477-1 to 477-N) that are associated with media content items that have been publicly shared by the user. In some example embodiments, the user has shared specific media content items with particular other users of the media content service, such that each user that visits the profile page of the first user will see only those media content items that the first user has specifically approved for viewing by that particular user.

In some example embodiments, the profile page view also includes a frames section. In some example embodiments, the frames section includes a frames navigation bar 415. In some example embodiments, the frames navigation bar 415 includes a user frames button 486, a selection tool button 468, and a search tool button 426.

In some example embodiments, selection of the user frames button 486 results in the frame device (e.g., device 102 in FIG. 1) altering the user interface to display the user currently displayed area 478. The user currently displayed area 478 includes a series of images (479-1 to 479-N) that each represent a media content item that is currently displayed at a frame device (e.g., device 102 in FIG. 1) owned by the user associated with the profile. Thus, if the user has ten frame devices that currently display media content items (e.g., pictures, videos, images, art, and so on), the user currently displayed area 478 has a maximum of ten images (e.g., one for each frame device).

In some example embodiments, the user can determine whether to share the media content items currently presented on each of their frame devices (e.g., device 102 in FIG. 1) on their profile page. In some example embodiments, users with a social connection to the user associated with the profile page are able to view the user currently displayed area 478. For example, User A is socially connected to User B, but User C is not socially connected to User B. When User A visits the profile page of User B, User A is able to view the media content items currently displayed on the frame devices (e.g., device 102 in FIG. 1) in the user currently displayed area 478 while User C would not be able to view any of the currently displayed media content items.

As with FIG. 4A, the user interface also includes a media content area. In some example embodiments, the media content area has a media content navigation bar 407 that includes a media content area button 430 to allow the user to return to the unfiltered media content area after conducting a search. The media content navigation bar 407 also includes a categories button 432, a search tool button 434, and a sort tool button 436. The media content area includes one or more filter tools 440 and a plurality of images (442-1 to 442-10),

FIG. 4D illustrates an exemplary user interface 400 for a user interface of a frame device in a complete media ecosystem in which media content items (e.g., images, art, video, etc.) are easily accessible to a user through a variety of areas and platforms as well as a search feature and a social feature. In this example, the user interface 400 includes a title bar 402 that displays the name of the media content service (e.g., Jotl or another service name). Below the title bar 402 is the navigation bar 403 that allows a user to quickly navigate from the home page to the currently trending media content items or the profiles of other users. The website navigation bar 403 includes a device selection button 404, an applications section button 406, a media content button 408, a store button 410, a home button 412, a messages 414 button, and a profile button 416.

In some example embodiments, the user interface also includes a secondary navigation bar 417. In some example embodiments, the secondary navigation bar 417 includes a timeline button 460, a friend's activity button 480, and a search tool button 426.

In some example embodiments, when the friend's activity button 480 is selected, the frame device (e.g., device 102 in FIG. 1) updates the user interface to includes a friend's content area 482. In some example embodiments, the friend's content area 482 includes one or more images (483-1 to 483-N)) that are each associated with specific media content items that have been shared by users of the media content service that are connected to the user of the frame device (e.g., device 102 in FIG. 1) through a social network associated with the media content service.

For example, User A has friended (made a social connection with) ten other users on the media content service. When User A selects the friend's activity button 480, the user interface displays the friend's content areas 482 that include images of media content items shared by the friends of User A.

In some example embodiments, the friends activity view also includes a frames section. In some example embodiments, the frames section includes a frames navigation bar 419. In some example embodiments, the frames navigation bar 419 in the friend's activity view includes a friend frames button 488, a selection tool button 468, and a search tool button 426.

In some example embodiments, selection of the friend frames button 488 results in the frame device (e.g., device 102 in FIG. 1) altering the user interface to display the friend's current content area 484. The friends' current content area 484 includes a series of images (485-1 to 485-N) that each represent a media content item that is currently displayed at a frame device (e.g., device 102 in FIG. 1) owned by a friend of the user signed into the frame device (e.g., device 102 in FIG. 1) currently displaying the associated with the profile. Thus, if the user has ten friends on the media content service with frame devices that are currently displaying media content items (e.g., pictures, videos, images, art, and so on), the friends' current content area 484 displays one or more media content items (each of which is associated with a particular frame device of another user).

As with FIG. 4A, the user interface also includes a media content area. In some example embodiments, the media content area has a media content navigation bar 407 that includes a media content area button 430 to allow the user to return to the unfiltered media content area after conducting a search. The media content navigation bar 407 also includes a categories button 432, a search tool button 434, and a sort tool button 436. The media content area includes on or more filter tools 440 and a plurality of images (442-1 to 442-10),

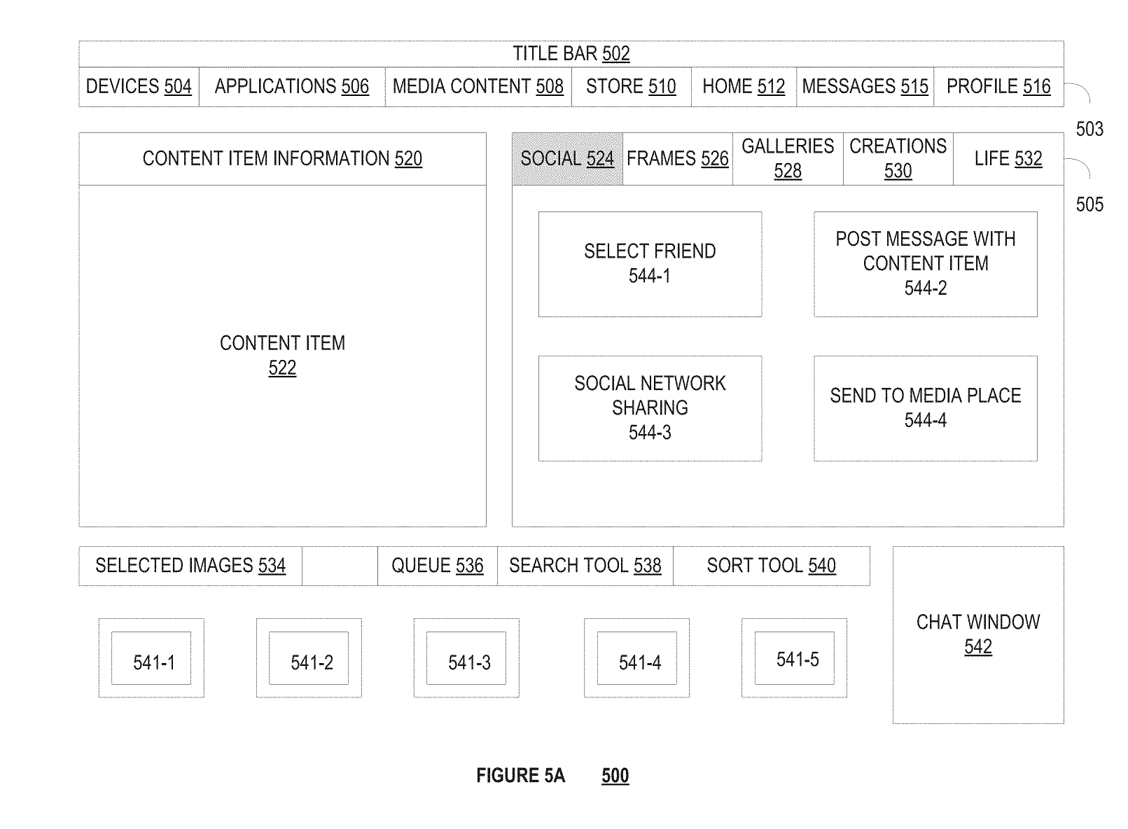

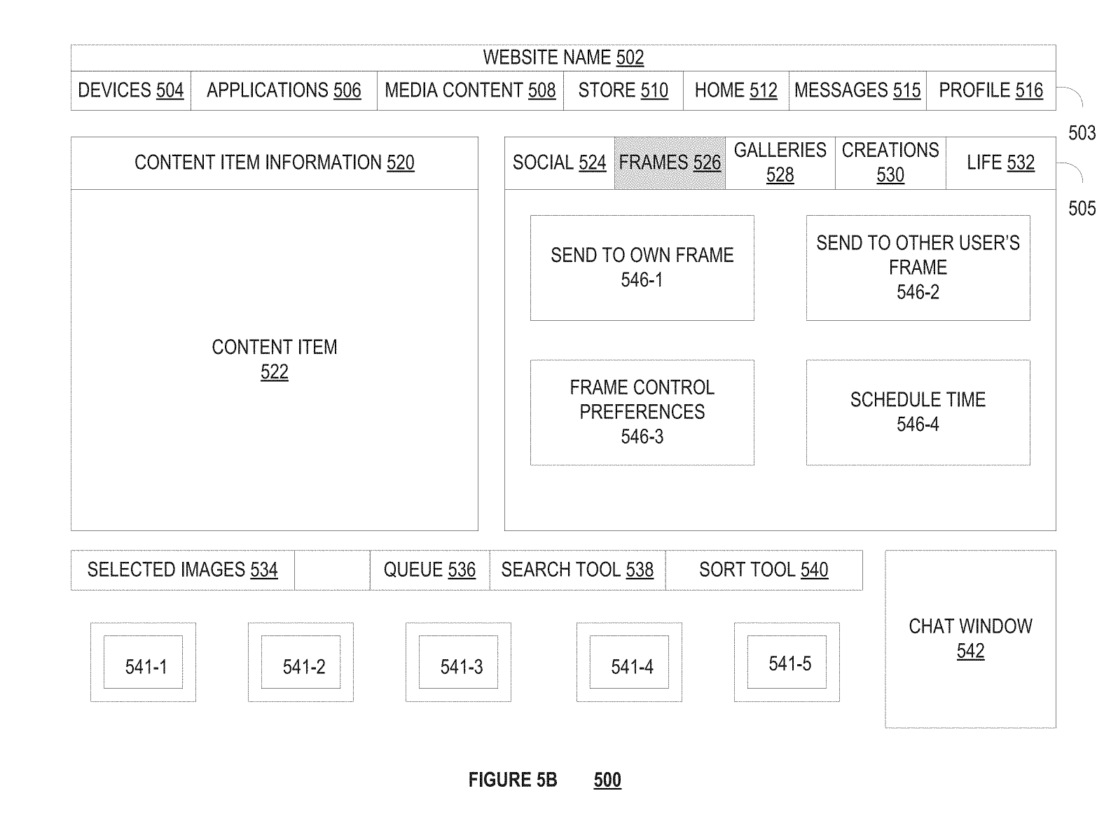

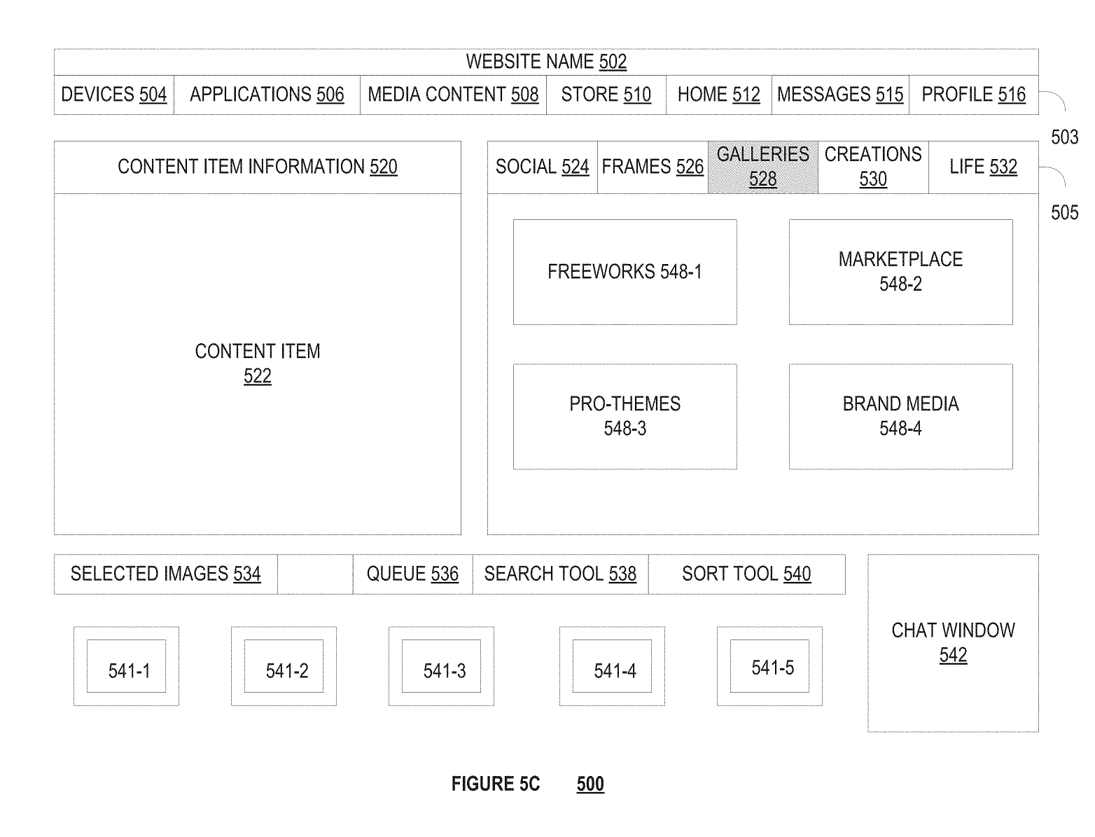

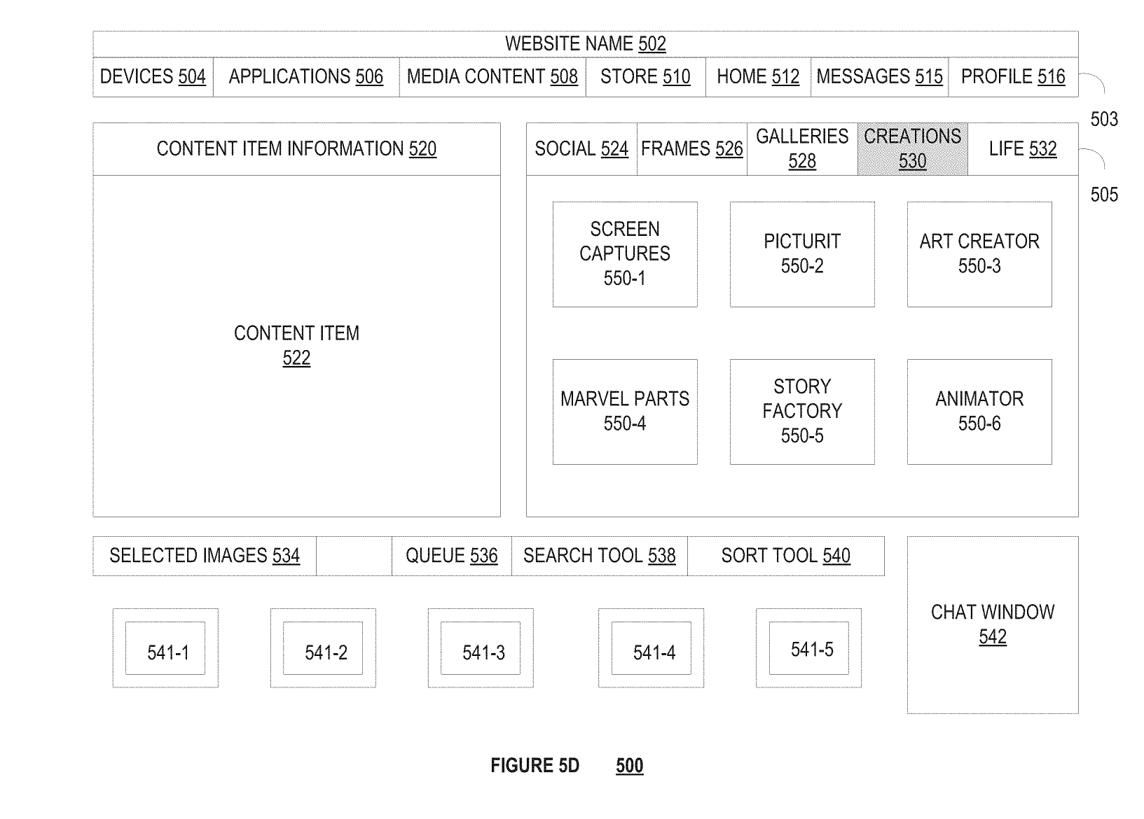

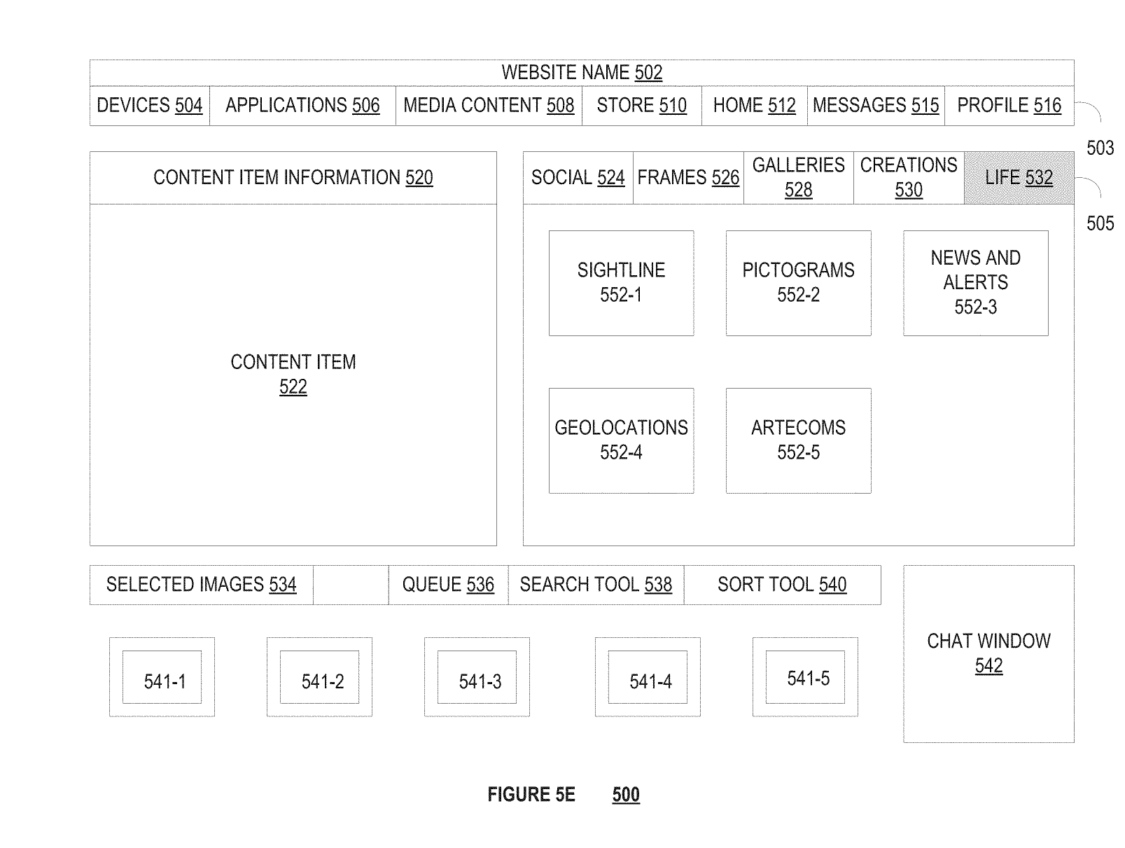

FIG. 5A illustrates an exemplary user interface 500 for a user interface of a frame device for organizing and selecting media content items in a complete media ecosystem in which media content items (e.g., images, art, video, etc.) are accessible. In this example, the user interface 500 includes a title bar 502 that displays the name of the media content service (e.g., Jotl or another service name) Below the title bar 502 is the navigation bar 503 that allows a user to quickly navigate through the user interface as efficiently as possible. The navigation bar 503 includes a device selection button 504, an applications section button 506, a media content button 508, a store button 510, a home button 512, a messages button 514, and a profile button 516.

In some example embodiments, the user interface also includes a content item information area 520. In some example embodiments, the content item information area 520 is displayed when a particular media content item is selected by a user. In some example embodiments, the content item information area 520 includes a name identifying the media content item. In some example embodiments, the content item information area 520 includes the content item display section 522. In some example embodiments, the content item display section 522 displays the selected media content item. In other example embodiments, the content item display section 522 displays an image associated with the selected media content item.

In some example embodiments, the user interface also includes a category display bar 505. In some example embodiments, the category display bar 505 includes a social button 524, a frames button 526, a galleries button 528, a creations button 530, and a life button 532.

In some example embodiments, when a user selects the social button 524, the frame device (e.g., device 102 in FIG. 1) updates the user interface to show the category display bar 505. In some example embodiments, the social category includes a select friend selection 544-1, a post message with content item 544-2, a social network sharing section 544-3, and send to media place section 544-4.

In some example embodiments, the select friend selection 544-1 allows a first user (e.g., the user who is currently operating the frame device (e.g., device 102 in FIG. 1) to choose another user that has previously connected to the first user through the media content service that is associated with the frame device (e.g., device 102 in FIG. 1). Once the friend (e.g., another user) is selected, the user can choose to send that user a message, send content to the user, and so on.

In some example embodiments, selection of the post message with content item button 544-2 results in a message being posted to a user associated stream of events (e.g., a personalized wall). In some example embodiments, media content item A is displayed in the content item area 522 of the user interface. The user selects the post message with content item button 544-2 and, as a result, the frame device (e.g., device 102 in FIG. 1) will post a message to the user's wall automatically, wherein the message includes media content item A. In some example embodiments, the user is able to attach a message to the post through a text prompt window.

In some example embodiments, the selection of the social network sharing button/area 544-3 results in the frame device (e.g., device 102 in FIG. 1) displaying additional options for sharing media content items further.

In some example embodiments, selection of the send to media place area/button 544-4 updates the user interface of the frame device (e.g., device 102 in FIG. 1) such that the user can send the media content item currently displayed in the content item area 522 to a media place destination of the user's choosing.

In some example embodiments, the user interface 500 includes a selected images area 534. In some example embodiments, the selected images area 534 has a queue button 536, a search tool 538, and a sort tool 540. In some example embodiments, the selected images area 534 includes a plurality of images associated with a media content item (541-1 to 541-5). In some example embodiments, the media content items that are listed are one or more items selected by a user.

In some example embodiments, selection of the queue button 536 results in a display of one or more additional images associated with media content items (potentially displacing the previously displayed one or more media content items) associated with one or more queues created by a user of the media content service. In some example embodiments, selection of the search tool 538 allows a user (e.g., via a text input box) to enter a query. In some example embodiments, the sort tool allows a user to sort media content items based on a selected sort criterion,

In some example embodiments, the user interface 500 includes a chat window 542 that allows one or more users to communicate with each other over the media content service associated with the frame device (e.g., device 102 in FIG. 1).

FIG. 5B illustrates an exemplary user interface 500 for a user interface of a frame device for organizing and selecting media content items in a complete media ecosystem in which media content items (e.g., images, art, video, etc.) are accessible. In this example, the user interface 500 includes a title bar 502 that displays the name of the media content service (e.g., Jotl or another service name) Below the title bar 502 is the navigation bar 503 that allows a user to quickly navigate through the user interface as efficiently as possible. The navigation bar 503 includes a device selection button 504, an applications section button 506, a media content button 508, a store button 510, a home button 512, a messages 515 button, and a profile button 516.

In some example embodiments, the user interface also includes a content item information area 520. In some example embodiments, the user interface also includes a category display bar 505. In some example embodiments, the category display bar 505 includes a social button 524, a frames button 526, a galleries button 528, a creations button 530, and a life button 532.

In some example embodiments, when a user selects the frames button 526, the frame device (e.g., device 102 in FIG. 1) updates the user interface to show a frames category area. In some example embodiments, the frame category area includes a send to own frame button 546-1, a send to other user's frame button 546-2, a frame control preferences button 546-3, and a schedule time button 546-4.

In some example embodiments, selection of the send to own frame 546-1 allows a user to send a selected media content item (e.g., the media content item displayed in the content item area 522) to a frame owned by the user. In some example embodiments, the user selects a particular frame from a list of a plurality of frames associated with the selecting user (e.g., the user logs into the media content service from the frame device (e.g., device 102 in FIG. 1) and receives a list of associated frame devices).

In some example embodiments, selection of the send to other user's frame button 546-2 results in the option for the user to send a selected media content item (e.g., the media content item displayed in the content item area 522) to a frame owned by another user of the media content service (e.g., a friend of the current user). In some example embodiments, the user selects a particular frame from a list of a plurality of frames associated with the selecting user (e.g., the user logs into the media content service from the frame device (e.g., device 102 in FIG. I) and receives a list of associated frame devices)

In some example embodiments, selection of the frame control preferences button 546-3 results in the frame device (e.g., device 102 in FIG. 1) updating the user interface to show control preferences for one or more frame devices for which the current user (e.g., the user signed onto the frame device (e.g., device 102 in FIG. 1)) has authority to control the preferences. In some example embodiments, the control preference interface lists a plurality of preference categories and the options available for each category. For example, the power usage settings for a frame device (e.g., device 102 in FIG. 1) can be controlled via the frame control preferences 546-3 or an associated interface such that the frame device powers down at a certain time (e.g., at 11 pm).

In some example embodiments, selection of the schedule time button 546-4 results in the frame device (e.g., device 102 in FIG. I) altering the user interface to display a schedule interface that allows the user to schedule specific times when certain media content items are to he displayed in advance. In some example embodiments, the schedule time interface can be used to arrange repeating patterns of media content items. For example, User A wants to view all the images in a certain collection every three minutes for an entire afternoon. User A uses the schedule time 546-4 button to instruct the frame device (e.g., device 102 in FIG. 1) to display images from that collection at the given rate.

In some example embodiments, the user interface 500 includes a selected images area 534. In some example embodiments, the selected images area 534 has a queue button 536, a search tool 538, and a sort tool 540. In some example embodiments, the selected images area 534 includes a plurality of images associated with a media content item (541-1 to 541-5). In some example embodiments, the media content items that are listed are one or more items selected by a user.

In some example embodiments, selection of the queue button 536 results in a display of one or more additional images associated with media content items (potentially displacing the previously displayed one or more media content items) associated with one or more queues created by a user of the media content service. In some example embodiments, selection of the search tool 538, allows a user (e.g., via a text input box) to enter a query. In some example embodiments, the sort tool allows a user to sort media content items based on a selected sort criterion.

In some example embodiments, the user interface 500 includes a chat window 542 that allows one or more users to communicate with each other over the media content service associated with the frame device (e.g., device 102 in FIG. I).

FIG. 5C illustrates an exemplary user interface 500 for a user interface of a frame device for organizing and selecting media content items in a complete media ecosystem in which media content items (e.g., images, art, video, etc.) are accessible. In this example, the user interface 500 includes a title bar 502 that displays the name of the media content service (e.g., Jotl or another service name) Below the title bar 502 is the navigation bar 503 that allows a user to quickly navigate through the user interface as efficiently as possible. The navigation bar 503 includes a device selection button 504, an applications section button 506, a media content button 508, a store button 510, a home button 512, a messages 515 button, and a profile button 516.

In some example embodiments, the user interface also includes a content item information area 520. In some example embodiments, the user interface also includes a category display bar 505. In some example embodiments, the category display bar 505 includes a social button 524, a frames button 526, a galleries button 528, a creations button 530, and a life button 532.

In some example embodiments, when a user selects the galleries button 528, the frame device (e.g., device 102 in FIG. 1) updates the user interface to show a galleries category area. In some example embodiments, the galleries category area includes a “Free Works” button 548-1, a marketplace button 548-2, a pro-themes button 548-3, and a brand media button 548-4.

In some example embodiments, selection of the “Free Works” button 548-1 allows a user to view of media content items that are classified as “Free Works.” All the media content items represented in the “Free Works” sub-area are made available on the media management system for free. In some implementations, the free works are content items created by a user on the central server and made free by the creator. In other implementations, the free works are media content items available from third party sources and imported into the media management system. In some implementations, free works include both media content items created on the central server (FIG. 1, 120) and free content imported into the system.

In some example embodiments, selection of the “Marketplace” button 548-1 allows a user to view media content items that are classified to be displayed in the “Market Place” sub-area. In some implementations, the “Market Place” sub-area includes one or more depictions or representations of media content items. In some implementations, the media content items represented in the “Market Place” sub-area are available for purchase. In other implementations, the media content items are media content items previously purchased by the user. In yet other implementations, media content items are works commissioned by the user and created by other users of the central server (FIG. 1, 120).

In some example embodiments, selection of the “Pro-Themes” button 548-3 results in display of a “Pro-Themes” subarea that includes one or more depictions or representations of media content items. In some implementations, professional creators of media content (e.g., artists) can sell their work through the “Pro-Themes” sub-area. Once purchased, the media content is then displayed in the “Pro Themes” sub-area. In some implementations, professionals can also offer services (commissioned work, tutoring, etc.) through the “Pro-Themes” sub-area.

In some example embodiments, selection of the “Brand Media” button 548-4 results in display of the “Brand Media” sub-area. In some example embodiments, the “Brand Media” sub-area 548-4 includes one or more depictions or representations of media content items. In some implementations, brands can offer media content items associated with their brand either free or for a fee. In some implementations, users can virally share branded materials thought the central server's (FIG. 1, 120) social features.

In some example embodiments, the user interface 500 includes a selected images area 534. In some example embodiments, the selected images area 534 has a queue button 536, a search tool 538, and a sort tool 540. In some example embodiments, the selected images area 534 includes a plurality of images associated with a media content item (541-1 to 541-5). In some example embodiments, the media content items that are listed are one or more items selected by a user.

In some example embodiments, the user interface 500 includes a chat window 542 that allows one or more users to communicate with each other over the media content service associated with the frame device (e.g., device 102 in FIG. 1).

FIG. 5D illustrates an exemplary user interface 500 for a user interface of a frame device for organizing and selecting media content items in a complete media ecosystem in which media content items (e.g., images, art, video, etc.) are accessible. In this example, the user interface 500 includes a title bar 502 that displays the name of the media content service (e.g., Jotl or another service name) Below the title bar 502 is the navigation bar 503 that allows a user to quickly navigate through the user interface as efficiently as possible. The navigation bar 503 includes a device selection button 504, an applications section button 506, a media content button 508, a store button 510, a home button 512, a messages 515 button, and a profile button 516.

In some example embodiments, the user interface also includes a content item information area 520. In some example embodiments, the user interface also includes a category display bar 505. In some example embodiments, the category display bar 505 includes a social button 524, a frames button 526, a galleries button 528, a creations button 53, and a life button 532.

In some example embodiments, when a user selects the creations button 530, the frame device (e.g., device 102 in FIG. 1) updates the user interface to show a creations category area. In some example embodiments, the creations category area includes a “Screen Captures” button 550-1, a “Picturit” button 550-2, an “Art Creator” button 550-3, a “Marvel Parts” button 550-4, a “Story Factory” button 550-5, and an “Animator” button 550-6.

In some example embodiments, selection of the “Screen Captures” button 550-1 results in display of the “Screen Captures” sub-area. In some example embodiments, the “Screen Captures” sub-area allows users to capture still images from a video presentation. The still images can then he used for presentation on a physical display. In some implementations, the central server (FIG. 1, 120) allows the rights owner of the video content (e.g., copy right holder) to determine whether a particular user is able to capture a screen shot from a particular piece of video content. Thus, when a user attempts to capture a screen shot, the system first determines whether they have permission from the applicable rights holder.

In some example embodiments, the rights assigned by the media content service are based on the social connection between the two users. Thus, an owner or creator of a video can allow users that are socially connected to (e.g., friends or contacts) to have rights to capture screenshots and so on that are not available to users that are not social contacts of the owner or the creator of a video. In some example embodiments, the sub-area also includes a capture tool, a list of already captured images from the selected video (or other media content item), albums to which the media content item belongs or in which the captured images can be stored, and a source list for any media content item displayed in the Screen Captures sub-area or captured in the sub-area.

In some example embodiments, selection of the “PicturIt” button 550-2 results in display of the “PicturIt” sub-area. In some example embodiments, the “PicturIt” sub-area allows users to convert media content items from one visual appearance to another. For example, users can apply filters to images to give them the appearance of a well-aged photograph or a cartoon-like appearance. In some example embodiments, the “PicturIt” sub-area includes one or more tools to use when converting media content items from one visual appearance to another including, but not limited to, selecting, moving, duplicating, undoing, and saving. In some example embodiments, the “PicturIt” sub-area also includes a list of filters and styles to use when editing or converting one or more media content items.

In some example embodiments, selection of the “Art Creator” button 550-3 results in display of the “Art Creator” sub-area. In some example embodiments, the “Art Creator” sub-area contains tools that allow users to create drawings and paintings in a variety of styles and simulated mediums. These images can then be shared with other users or transmitted to physical devices for display. In some implementations, the central server (FIG. 1, 120) stores the creation process for a piece of art for later replay. For example, an artist uses a touch screen device to create a painting. Each “brushstroke” (e.g., a swipe or touch) is recorded. Later, if a user wishes to see the creation process, the system can replicate the creation process, stroke by stroke.

In some example embodiments, selection of the “Marvel Parts” button 550-4 results in display of the “Marvel Parts” sub-area. In some example embodiments, the “Marvel Parts” sub-area contains tools that allow users to analyze a media content item, identify specific parts and templates within the media, and save the parts and templates for later use. In some implementations, the parts and templates can be used in conjunction with the “Art Creator” sub area or the “PicturIt” sub-area for creating new images or works of art. For example, if the system analyzes a family picture, it can identify each family user and create a separate image part file containing each family user separately. The user can then create new images with the individual family users rearranged or included in different scenes.

In some example embodiments, the “Marvel Parts” sub-area includes tools that allows one or more various identified parts into one or more albums in response to selection by the user. In some example embodiments, the identified parts can be shared with other users such that the other users are able to use the parts in their own creations. In some example embodiments, a user can determine whether users can access their parts on a case by case basis. In other example embodiments, a user can allow users to access identified groups based on the social connections between users. For example, User A allows all connected users (e.g., socially connected) to access “Marvel Parts” created by User A but restricts non-connected users from accessing the parts.

In some implementations, the rights owners determine whether a given user is able to extract parts and templates from a given work. In some implementations, the central server (FIG. 1, 120) determines whether a given user has permission to create parts or templates prior to enabling the user to derive parts and templates from a media content item. In some implementations, a user can share parts and templates with other users of the system. For example, if a user attempts to analyze a movie still, the system will ensure that they have the legal right to do so.

In some example embodiments, selection of the “Story Factory” button 550-5 results in display of the “Story Factory” sub-area. In some example embodiments, the “Story Factory” sub-area contains tools that allow users to create a series of images that convey or represent a story. In some implementations, a user creates a group of images in a specific order in order to tell a story through the images. The created group of images has an associated flip frequency that determines how quickly each image is replaced. In this way the group of story images functions like a slide show, graphic novel, a story board for a movie, or any other visual story format.

In some example embodiments, the creations section also includes an “Emergineering” button. In some example embodiments, the “Emergineering” sub-area contains tools that allow users to determine how a media content item is displayed on a physical display. By default, a media content item is displayed all at once. For example, a painting is entirely rendered on a display effectively instantly. However, users can customize how a visual work emerges on a display. For example, once an image has been analyzed to identify particular parts or templates, the user can choose to have each part displayed in a particular order, such that the image is displayed one piece at a time until the full media content item is presented. In some implementations, the media content item contains creation data (e.g., data that outlines the creation of the media content). The central server (FIG. 1, 120) then can recreate the work in the same manner as it was created. For example, a child creates a painting for a parent using a touch sensitive electronic device. The device stores each finger touch and transmits it to the central server (FIG. 1, 120) along with the final painting. The parent can then choose to have the painting displayed based on each finger touch such that the presentation recreates the child's creation of the image.

In some example embodiments, selection of the “Animator” button 550-6 results in display of the “Animator” sub-area. In some example embodiments, the “Animator” sub-area contains tools that allow users to create animations from still images, templates, and parts. For example, a user of the central server (FIG. 1, 120) uses a character part to create a series of still images with the character moving from one side of the frame to the other. The central server (FIG. 1, 120) then automatically converts the images to computer graphics and animates the frames into one continuous animation.

In some example embodiments, the user interface 500 includes a selected images area 534. In some example embodiments, the selected images area 534 has a queue button 536, a search tool 538, and a sort tool 540. In some example embodiments, the selected images area 534 includes a plurality of images associated with a media content item (541-1 to 541-5). In some example embodiments, the media content items that are listed are one or more items selected by a user.

In some example embodiments, the user interface 500 includes a chat window 542 that allows one or more users to communicate with each other over the media content service associated with the frame device (e.g., device 102 in FIG. 1),

FIG. 5E illustrates an exemplary user interface 500 for a user interface of a frame device for organizing and selecting media content items in a complete media ecosystem in which media content items (e.g., images, art, video, etc.). In this example, the user interface 500 includes a title bar 502 that displays the name of the media content service (e.g., Jotl or another service name). Below the title bar 502 is the navigation bar 503 that allows a user to quickly navigate through the user interface as efficiently as possible. The navigation bar 503 includes a device selection button 504, an applications section button 506, a media content button 508, a store button 510, a home button 512, a messages 515 button, and a profile button 516.

In some example embodiments, the user interface also includes a content item information area 520. In some example embodiments, the user interface also includes a category display bar 505. In some example embodiments, the category display bar 505 includes a social button 524, a frames button 526, a galleries button 528, a creations button 530, and a life button 532.

In some example embodiments, when a user selects the life button 532, the frame device (e.g., device 102 in FIG. 1) updates the user interface to show a life category area. In some example embodiments, the creations category area includes a “Sightline” button 552-1, a “Pictograms” button 552-2, a “News and Alerts” button 552-3, a “Geolocations” button 552-4, and an “Artecoms” button 552-5.

In some example embodiments, the life section includes a “Sightline” button 552-1. In some example embodiments, the “Sightline” sub-area (e.g., displayed in response to selection of the “Sightline” button 552-1) includes tools that allow users to designate certain media content items that the user desires to frequently be displayed or available to them. In some implementations, the media content includes images, text, quotations, religious messages, to do lists, goals, menus, and calendar notifications. In some implementations, the user can combine important text with backgrounds, schemes, and parts stored in the central server (FIG. 1, 120) to create important images.

In some implementations, the central server (FIG. 1, 120) has some ability to track user location (e.g., GPS sensors in a smart phone) and automatically present materials as a user moves nearer to different physical displays throughout the day. For example, a to do list is displayed at home as the user gets ready for work and, when the central server (FIG. 1, 120) determines that the user has reached his or her office, the to do list is then presented in a frame at work. In some implementations, a first user will arrive near a display owned by a second user of the system and, if the second user has set permissions to allow it, the system will display media content from the “Sightline” sub-area while the first user remains near the second user's display.

In some example embodiments, the life section also includes a “Pictograms” button 552-2. In some example embodiments, the “Pictograms” sub-area includes tools that allow users to send visual messages to frames owned and controlled by other users. In some implementations, a first user creates an image with a specific meaning (e.g., a happy birthday image) and sends it to a second user. In other implementations, the first user selects a type of message and the message content, and the central server (FIG. 1, 120) automatically selects specific images to meet the first user's request and displays the created pictogram at a physical display in the proximity of the second user.

In yet other implementations, the first user enters a text only message and the central server (FIG. 1, 120) automatically converts the text message to a pictogram that, when displayed to a second user, conveys the message of the original text message. For example, the first user enters the message “Hey Brad, let's meet at Rodigio's for lunch at 1:15 pm.” The central server (FIG. 1, 120) then selects appropriate imagery, such as a picture of the indicated restaurant and a clock showing the proposed time, creates a pictogram, and presents the image at a physical display in the proximity of the intended recipient, Brad.

In some example embodiments, the user assigns an image (or one or more image parts and themes) to a specific pictogram message. In some example embodiments, the user can access a list of potential images or image parts to choose from when selecting an image or image part to include with a message. In some example embodiments, the user chooses a theme and the frame device (e.g., device 102 in FIG. 1) automatically fills in one or more appropriate parts.

In some example embodiments, the life section also includes a “News and Alerts” button 552-3. In some example embodiments, the “News and Alerts” sub-area includes one or more media content items that are related to current news, weather, calendar reminders, announcements, and any topics the user has requested to be updated on. In some example embodiments, the frame device (e.g., device 102 in FIG. 1) receives one or more media content items from a central server based on the settings or preferences associated with the user of the frame device (e.g., device 102 in FIG. 1). For example, the central server (FIG. 1, 120) monitors news feeds and generates (or selects) images related to important news events.

In some example embodiments, for each selected or generated image, the central server (FIG. 1, 120) sends the images to frame devices (e.g., device 102 in FIG. I) determined to match the implicit or explicit interest of the associated user. The frame device (e.g., device 102 in FIG. 1) then displays each received media content item in the “News and Alerts” sub-area. In some implementations, users can create and share their own includes tools that allow users to send visual messages to frames owned and news or alert related images in the “News and Alerts” sub-area.

In some example embodiments, the life section also includes a “GeoLocations” button 552-4. In some example embodiments, the “GeoLocations” sub-area includes tools that allow users to collect and assign images for use with GPS technology in electronic devices. Thus, as the user travels around, an image associated with their current location is updated. For example, user A has assigned a frame device (e.g., device 102 in FIG. 1) at his home to reflect his current location. When User A is at work, the frame device (e.g., device 102 in FIG. 1) shows an image related to work. When User A leaves work and goes to the gym, the image changes to an image assigned to the gym. In this way, User A's family can follow his location merely by viewing the image display on the assigned display. In some implementations, a user can record the images assigned with their location over a certain period of time to create a travelogue slideshow for a given period of time.

In some example embodiments, the life section also includes an “Artecoms” button 552-5. In some example embodiments, the “Artecoms” sub-area includes tools that allow users to collect and assign various communication parts and characters to form a pictorial language (e.g., a method for communicating the message in images rather than strictly in text.) This pictorial language can then be used to send and receive messages through the central server (FIG. 1, 120). In some implementations the “Life Apps Plus” sub-area includes tools that extend the life apps features and tools for businesses and commercial ventures.

In some example embodiments, the user interface 500 includes a selected images area 534. In some example embodiments, the selected images area 534 has a queue button 536, a search tool 538, and a sort tool 540. In some example embodiments, the selected images area 534 includes a plurality of images associated with a media content item (541-1 to 541-5). In some example embodiments, the media content items that are listed are one or more items selected by a user.

In some example embodiments, the user interface 500 includes a chat window 542 that allows one or more users to communicate with each other over the media content service associated with the frame device (e.g., device 102 in FIG. 1).

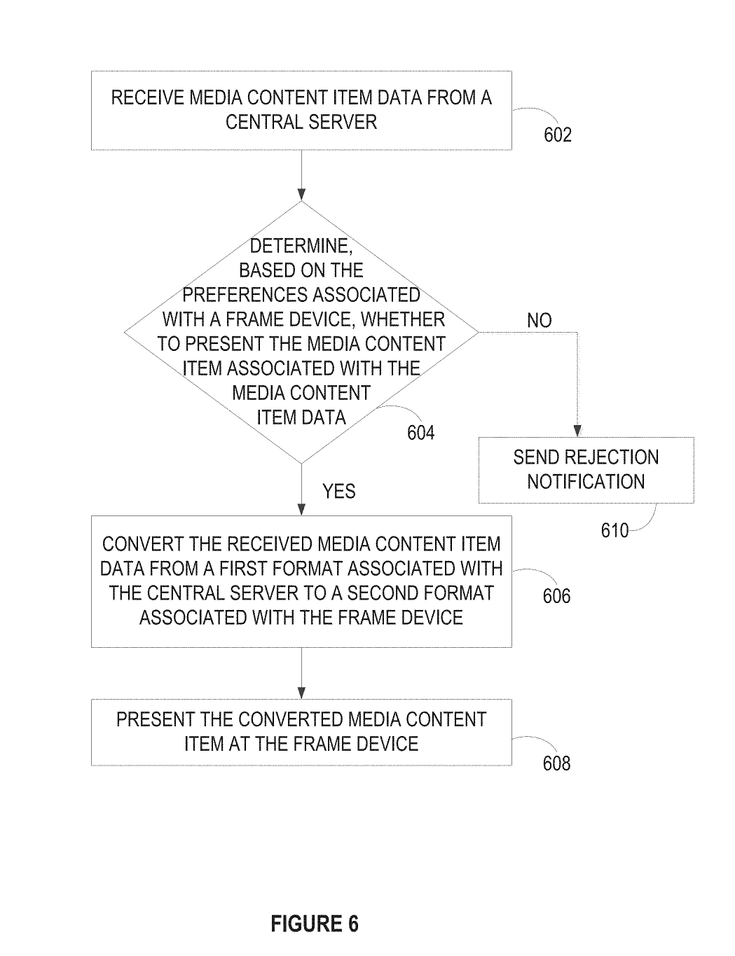

FIG. 6 is a flow diagram illustrating a method, in accordance with some example embodiments, for receiving and presenting data through frame devices integrated with a socially networked artwork ecosystem. Each of the operations shown in FIG. 6 may correspond to instructions stored in a computer memory or computer-readable storage medium. Optional operations are indicated by dashed lines (e.g., boxes with dashed-line borders). In some embodiments, the method described in FIG. 6 is performed by the frame device (e.g., device 102 in FIG. 1). However, the method described can also be performed by any other suitable configuration of electronic hardware.

In some embodiments, the method is performed at a frame device (e.g., device 102 in FIG. 1) including one or more processors and memory storing one or more programs for execution by the one or more processors.

In some example embodiments, a frame device (e.g., device 102 in FIG. 1) is associated with a socially networked artwork ecosystem. In some example embodiments, the socially networked artwork ecosystem is linked to the frame device (e.g., device 102 in FIG. 1) as a server system over a computer network. In some example embodiments, users can log into the socially networked artwork ecosystem via the frame device (e.g., device 102 in FIG. 1) and can then access data and services associated with the user through the frame device (e.g., device 102 in FIG. 1).

In some example embodiments, the frame device (e.g., device 102 in FIG. 1) receives (602) media content item data from a central server. In some example embodiments, the central server is a server associated with (or hosting) a socially networked artwork ecosystem. In some example embodiments, the content media item data includes all the data needed to present the associated media content item at a frame device (e.g., device 102 in FIG. 1).

In other example embodiments, the media content item data includes only a data transmission confirmation request, :In some example embodiments, a data transmission confirmation request is a request to determine whether the central server should transmit all the data needed to present an associated media content item. In this way, the full data is only sent when the frame device (e.g., device 102 in FIG. 1) confirms that the associated media content item is allowed to be presented on the frame device (e.g., device 102 in FIG. 1).

In some example embodiments, the frame device (e.g., device 102 in FIG. 1) determines (604) based on the preferences associated with the frame device, whether to present the media content item associated with the media content item data. In some example embodiments, the preference data determines what type of media content item can be presented, when the frame device (e.g., device 102 in FIG. 1) is available for new media content items, and who is allowed to change the currently presented media content item.

For example, Frame Device A is current presenting a still image. It receives, from the central server, a request to display a video that originated from another user. Frame Device A determines that for the time period in question, Frame Device A only shows silent media content items and thus cannot present the video, even though the user that initiated the request would normally be allowed to alter the presented media content item at Frame Device A.

In accordance with a determination that the media content item associated with the received media content data is allowed to be presented at the frame device (e.g., device 102 in FIG. 1), the frame device (e.g., device 102 in FIG. 1) then converts (606) the media content item data from a first format associated with the central server (e.g., a format that allows easier transmission and can be converted to a variety of frame device formats) into a second format associated with the frame device (e.g., device 102 in FIG. 1),

In some example embodiments, once the media content item data has been converted, the frame device (e.g., device 102 in FIG. 1) presents (608) the media content item.

In some example embodiments, the frame device (e.g., device 102 in FIG. 1) determines, based on preferences of the frame device (e.g., device 102 in FIG. 1), that the media content item associated with the received media content item data should not be presented. In response, the frame device (e.g., device 102 in FIG. 1) sends (610) a rejection notification to the central server (e.g., a notification that the frame device (e.g., device 102 in FIG. 1) will not be presenting the media content item).

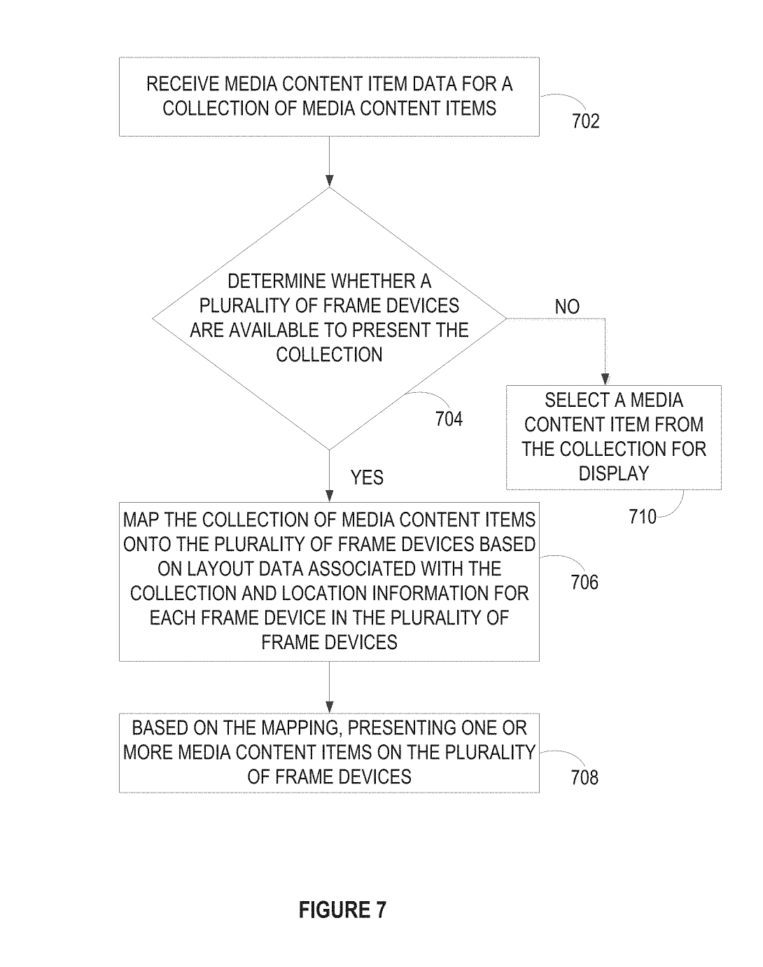

FIG. 7 is a flow diagram illustrating a method, in accordance with some example embodiments, for displaying a collection over a plurality of frame devices. Each of the operations shown in FIG. 7 may correspond to instructions stored in a computer memory or computer-readable storage medium. Optional operations are indicated by dashed lines (e.g., boxes with dashed-line borders). In some embodiments, the method described in FIG. 7 is performed by the frame device (e.g., device 102 in FIG. 1). However, the method described can also be performed by any other suitable configuration of electronic hardware.

In some embodiments the method is performed at a frame device (e.g., device 102 in FIG. 1) including one or more processors and memory storing one or more programs for execution by the one or more processors.

In some example embodiments, a plurality of media content items are organized into a collection. For example, an artist can create a collection of paintings that are intended to be displayed together. This collection can then be grouped together as a whole in the central server.

In some example embodiments, the frame device (e.g., device 102 in FIG. 1) receives (702) media content item data for a collection of media content items. As noted above, media content items can be grouped into a connected collection. In some example embodiments, a collection of media content items also includes data (e.g., metadata) that describes how the collection of media content items are intended to be displayed. For example, a creator of a collection can designate the order that the media content items should be viewed or the relative position of two media content items. Thus, a series of frame devices (e.g., device 102 in FIG. 1) would order the media content items such that a guest would see the media content items in a particular order when walking down the hallway.

In some example embodiments, the frame device (e.g., device 102 in FIG. 1) determines (704) whether a plurality of frame devices are available to present the collection simultaneously. For example, the frame device (e.g., device 102 in FIG. 1) determines, based on a profile associated with the user who owns the frame device (e.g., device 102 in FIG. 1), whether a plurality of frame devices are available nearby to present the collection. In some example embodiments, the frame device (e.g., device 102 in FIG. 1) uses a local area network to detect nearby frame devices.

In some example embodiments, in accordance with a determination that a plurality of frame devices are available to present the collection simultaneously, the frame device (e.g., device 102 in FIG. 1) maps (706) the collection of media content items onto the plurality of frame devices based on layout data associated with the collection (e.g., data describing how the collection should be presented in a space) and location information for each frame device in the plurality of frame devices (where each frame is in space relative to each other).

For example, if the layout data for a collection indicate that two images should be presented beside each other, if possible, the frame device (e.g., device 102 in FIG. 1) searches the list of frame devices to identify two frame devices that are located next to teach other. The frame device (e.g., device 102 in FIG. 1) will then assign the two images to be presented in the identified frame devices beside each other.

In some example embodiments, once the collection of images has been mapped to the plurality of frame devices, the frame device (e.g., device 102 in FIG. 1) presents (or causes to be presented) (708) some or all of the collection of media content items to be presented by the plurality of frame devices.

In some example embodiments, the number of media content items is greater than the number of usable frame devices. In this case, the frame device (e.g., device 102 in FIG. 1) determines which media content items in the collection to display and when to display them. In some example embodiments, the frame device (e.g., device 102 in FIG. 1) can rotate through the entire collection, displaying each media content item for a least some time.

In some example embodiments, the frame device (e.g., device 102 in FIG. 1) determines that a plurality of frame devices are not available. In response, the frame device (e.g., device 102 in FIG. 1) selects (710) a media content item in the collection and presents on a display associated with the frame device (e.g., device 102 in FIG. 1).

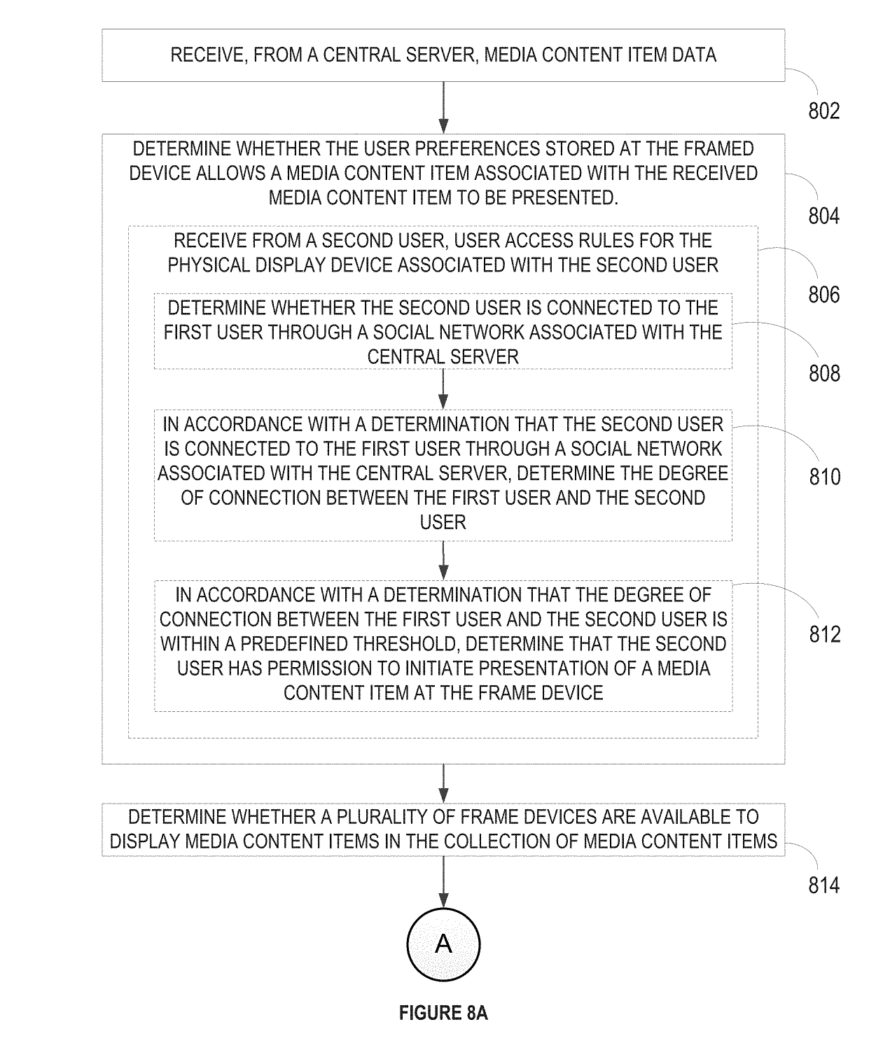

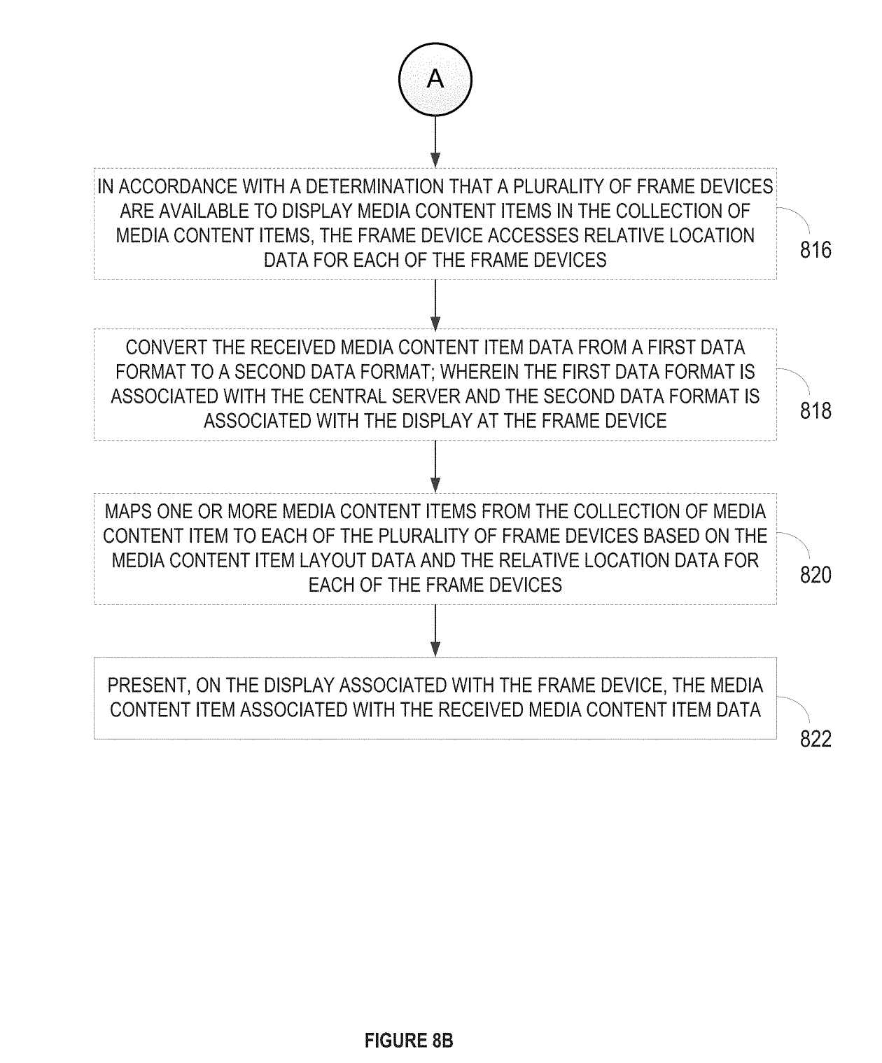

FIG. 8A is a flow diagram illustrating a method, in accordance with some example embodiments, for using a dedicated frame device to receive and present media content items from a media content service with a social networking component. Each of the operations shown in FIG. 8A may correspond to instructions stored in a computer memory or computer-readable storage medium. Optional operations are indicated by dashed lines (e.g., boxes with dashed-line borders). In some embodiments, the method described in FIG. 8A is performed by the frame device (e.g., device 102 in FIG. 1). However, the method described can also be performed by any other suitable configuration of electronic hardware.

In some embodiments, the method is performed at a frame device (e.g., device 102 in FIG. 1) including one or more processors and memory storing one or more programs for execution by the one or more processors and wherein the frame device includes a display.

In some example embodiments, the display associated with the frame device (e.g., device 102 in FIG. 1) is an c-paper display. In some example embodiments, other display types can also be used. In some example embodiments, c-paper displays have the advantage of being able to display, to the best satisfaction of a user, artwork that was originally intended to be displayed on paper or on canvas (e.g., a painting).

In some example embodiments, the frame device (e.g., device 102 in FIG. 1) receives (802) item data from a central server media content. In some example embodiments, the frame device (e.g., device 102 in FIG. 1) is associated with a first user. :In some example embodiments, the first user is the user that owns the frame device (e.g., device 102 in FIG. 1). In other example embodiments, the first user is merely the user that is currently logged into a central server through the frame device (e.g., device 102 in FIG. 1). For example, a frame device is available in the common room of an apartment. One of the occupants of the apartment is generally at home in the afternoon and logs into the central server via the frame device (e.g., device 102 in FIG. 1) during that time. Another occupant is generally at home in the evening and they log into the frame device (e.g., device 102 in FIG. 1) during that time of the day.

In some example embodiments, the media content item data is received from the central server in response to a request from a first user. In some example embodiments, the first user sends the request directly through the frame device (e.g., device 102 in FIG. 1). For example, the user uses the frame device to view a plurality of media content items that can be displayed at the frame device (e.g., device 102 in FIG. 1). The user then selects one, using the user interface of the frame device, and, in response, the central server transmits the requested media content item data to the frame device (e.g., device 102 in FIG. 1). In other example embodiments, the first user can send the request via another computer system such as a mobile device (e.g., phone or tablet) or computer (e.g., a desktop computer)

In other example embodiments, the media content item data is received from the central server in response to a request from a second user that is not associated with the frame device (e.g., device 102 in FIG. 1). Thus, a user that is not currently logged onto the frame device can send a request to initiate presentation of a media content item that is not currently presented at the frame device (e.g., device 102 in FIG. 1). For example. user B, who knows user A, sends a painting that user B likes to a frame device owned by user A. In this way, user B can share media content items with other users.

In some example embodiments, the media content item data is received from the central server based on a popularity rating from other users of the central server. In this case, the central server determines, based on information stored about the first user and popularity data about a particular media content item, that the first user is likely interested in viewing the recommend media content item. In some example embodiments, recommendations are determined automatically by the central server and users can update their preferences to determine whether such recommendations can be presented on any given frame device. For example, User A has a long history of enjoying impressionist paintings and has a particular frame device that allows new recommendations to be displayed so that User A can discover new and interesting artwork that matches their interests.

In some example embodiments, the popularity rating is based only on users that are connected through a social network associated with the central server to a first user associated with the frame device. In this case, the central server stores social networking data for the users of the central server, such that users can connect with each other (e.g., chat, talk, send images and messages) and form social connections (e.g., accept and send friend requests and join interest groups). In this case, the central server uses the collected social graph data to determine users that are within a first users social connection circle. The central server can then limit its recommendations to media content items that are popular within the social circle of the first user by only considering popularity of a media content item within that particular social group.

In some example embodiments, the received media content item data is associated with a collection of media content items, and the media content item data includes media content item layout data. For example, a particular creator of media content items can create a collection of images that are intended to be displayed as part of a multi-image exhibition. The images can then be sent as a collection to users, such that, if the user has more than one frame device (e.g., device 102 in FIG. 1), multiple works from the collection can be displayed simultaneously, allowing a user to recreate the feeling of an art exhibition.

In some example embodiments, the media content item layout data is metadata describing how the plurality of media content items is intended to be displayed (e.g., by a creator of a collection) such that an art viewing experience can be created and maintained wherever possible. In some example embodiments, the media content item layout data includes information about what types of displays each media content item is best presented on, what settings should be used for a given device type, and what layout the media content items should have relative to each other. For example, a creator includes instructions that image A should be displayed to a user before image B. Thus, when planning how to display the collection in a plurality of frame devices (e.g., device 102 in FIG. 1), the frame device (e.g., device 102 in FIG. 1) selects a frame device to display image A that will be encountered before a frame device that displays image B (e.g., the first frame device in a hallway will be viewed before the last frame device in a hallway).

In some example embodiments, the frame device (e.g., device 102 in FIG. 1) determines (804) whether the user preferences stored at the framed device allows a media content item associated with the received media content item to be presented.

In some example embodiments, determining whether the user preferences stored at the framed device allow a media content item associated with the received media content item to be presented further comprises, determining (806) whether the second user has permission to initiation presentation of a media content item at the frame device. For example, a first user (e.g., the owner of the frame device) can establish a list (e.g., a whitelist) of users that are able to initiate presentation of a media content item at a particular frame device (e.g., device 102 in FIG. 1). The frame device (e.g., device 102 in FIG. 1) can then check the user identification for the user that initiated transmission of the media content item data to the frame device (e.g., device 102 in FIG. 1) and determine whether the user is on the list. If so, the frame device (e.g., device 102 in FIG. 1) determines that the user preferences stored at the framed device do allow the media content item associated with the received media content item to be presented.

In other example embodiments, the user preferences restrict use of the frame device by outside users by time (e.g., other users can only initiate change of the currently displayed media content item during certain days/times) or by content item type (e.g., only certain types of media content items can be displayed at a particular frame device (e.g., device 102 in FIG. 1).

In some example embodiments, a frame device device 102 in FIG. 1) determines (808) whether the second user is connected to the first user through a social network associated with the central server. For example, the central server stores a social graph data for each of its users. This social graph data determines which users a first user is connected to, which users the first user's connections are connected to, which groups the first user has joined, and so on. Thus, for any two users of the central server, the central server can determine whether they are connected through the stored social graph data in anyway.

In some example embodiments, in accordance with a determination that the second user is connected to the first user through a social network associated with the central server, the frame device (e.g., device 102 in FIG. 1) determines (810) the degree of connection between the first user and the second user. For example, if the first user and the second user have added each other as “friends” or other social connections, the frame device (e.g., device 102 in FIG. 1) determines that the two users are connected in the first degree or have a first order connection. In another example, if the first user and the second user have several common friends but are not directly connected, the frame device device 102 in FIG. 1) may determine that they have a strong second degree connection. In some example embodiments, the more common connections, the stronger the degree of connection between two users.

In some example embodiments, the frame device (e.g., device 102 in FIG. 1) also determines whether the first user and the second user have joined any common interest groups and are connected through common interests.

In some example embodiments, in accordance with a determination that the degree of connection between the first user and the second user is within a predefined threshold, the frame device (e.g., device 102 in FIG. 1) determines (812) that the second user has permission to initiate presentation of a media content item at the frame device (e.g., device 102 in FIG. 1). In some example embodiments, the predefined threshold is determined by the first user. For example, the first user can establish that any first degree contacts have a first set of permissions with regards to one or more frame devices (e.g., device 102 in FIG. 1) associated with the first user and that any second degree contacts have a second set of permissions.

For example, the first set of permissions allow first degree contacts to initiate presentation of a new media content item at any frame device so long as it does not conflict with a specific scheduled media content item presentation. The second set of permissions restricts second degree contacts to initiate only at a. predefined list of frame devices (e.g., device 102 in FIG. 1), only during predefined times, and only with certain types of media content items.

In some example embodiments, the frame device (e.g., device 102 in FIG. 1) determines (814) whether a plurality of frame devices are available to display media content items in the collection of media content items. In some example embodiments, the frame device is connected, via a local network, to other frame devices associated with the first user. In other example embodiments, the frame device (e.g., device 102 in FIG. 1) uses profile data about the first user to determine, how many, if any, other frame devices are available for use in the area of the first frame device (e.g., device 102 in FIG. 1). For example, a frame device determines, based on profile information for the first user, that the first user's house has seven available frame devices to display one or more media content items in a collection of media content items.

FIG. 8B is a flow diagram illustrating a method, in accordance with some example embodiments, for using a dedicated frame device to receive and present media content items from a media content service with a social networking component. Each of the operations shown in FIG. 8B may correspond to instructions stored in a computer memory or computer-readable storage medium. Optional operations are indicated by dashed lines (e.g., boxes with dashed-line borders). In some embodiments, the method described in FIG. 8B is performed by the frame device (e.g., device 102 in FIG. 1). However, the method described can also be performed by any other suitable configuration of electronic hardware.

In some embodiments, the method is performed at a frame device (e.g., device 102 in FIG. 1) including one or more processors and memory storing one or more programs for execution by the one or more processors.

In some example embodiments, in accordance with a determination that a plurality of frame devices are available to display media content items in the collection of media content items, the frame device (e.g., device 102 in FIG. 1) accesses (816) relative location data for each of the frame devices. For example, the frame device (e.g., device 102 in FIG. 1) stores (or retrieves from another system) data describing the position and orientation of each frame device (e.g., device 102 in FIG. 1) that is currently available to display one or more media content items in the collection of media content item.

For example, a space has five frame devices, and the relative location data for each describe where the frame is within the space (e.g., using global position system co-ordinates), the orientation of the frame, the areas of the space from which the frame is visible, the height of the frame in space, and the order in which the frame is likely to be encountered given normal travel patterns within the space. In some example embodiments, the relative location data also describes the location of the frame relative to other frames within the space.

In some example embodiments, the frame device (e.g., device 102 in FIG. 1) maps (820) one or more media content items from the collection of media content item to each of the plurality of frame devices based on the media content item layout data and the relative location data for each of the frame devices. For example, the frame device determines, based on media content item layout data, that the five paintings in a collection are preferred to be viewed in a given order.

The frame device (e.g., device 102 in FIG. 1) then determines, based on the relative location data of the other frame devices (e.g., device 102 in FIG. 1) and walking paths trends within the space, which frame device (e.g., device 102 in FIG. 1) is likely to be encountered first for a typical user. The frame device (e.g., device 102 in FIG. 1) then maps the first painting to the first encountered frame device (e.g., device 102 in FIG. 1) and so on until all the media content items are mapped to at least one frame device (e.g., device 102 in FIG. 1).

In some example embodiments, the frame device (e.g., device 102 in FIG. 1) converts (818) the received media content item data from a first data format to a second data format, wherein the first data format is associated with the central server and the second data format is associated with the display at the frame device.

In some example embodiments, the frame device (e.g., device 102 in FIG. 1) presents (822), on the display associated with the frame device, the media content item associated with the received media content item data.

### Software Architecture

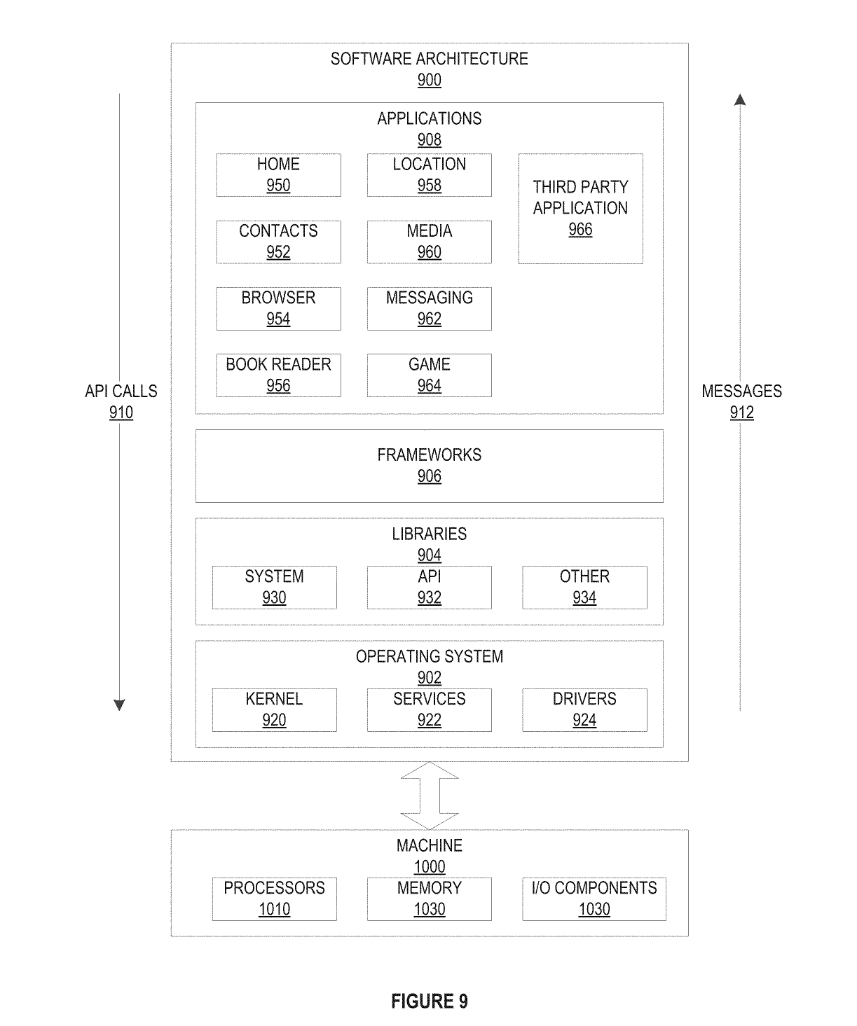

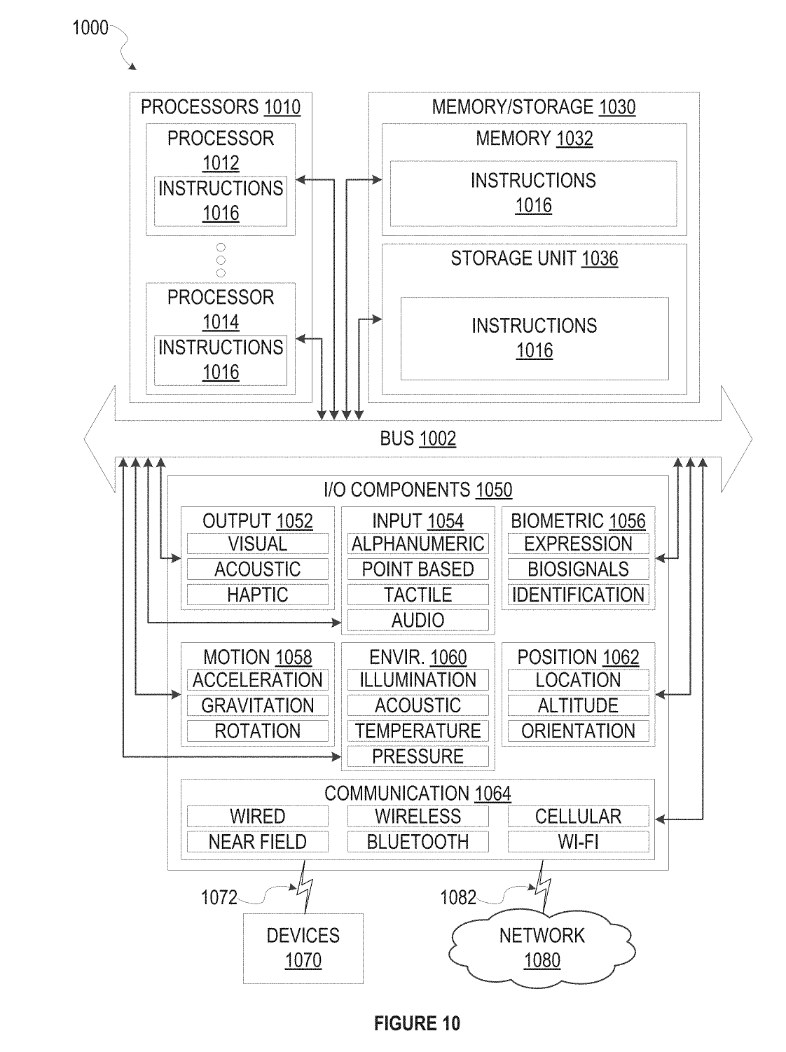

FIG. 9 is a block diagram illustrating an architecture of software 900, in accordance with an example embodiment, which may be installed on any one or more of the devices of FIG. 1 (e.g., the frame device 102). FIG. 9 is merely a non-limiting example of a software architecture and it will be appreciated that many other architectures may be implemented to facilitate the functionality described herein. The software 900 may be executing on hardware such as a machine 1000 of FIG. 10 that includes processors 1010, memory 1030, and 110 components 1050. In the example architecture of FIG. 9, the software 900 may be conceptualized as a stack of layers where each layer may provide particular functionality. For example, the software 900 may include layers such as an operating system 902, libraries 904, frameworks 906, and applications 908. Operationally, the applications 908 may invoke API calls 910 through the software stack and receive messages 912 in response to the API calls 910.

The operating system 902 may manage hardware resources and provide common services. The operating system 902 may include, for example, a kernel 920, services 922, and drivers 924. The kernel 920 may act as an abstraction layer between the hardware and the other software layers. For example, the kernel 920 may be responsible for memory management, processor management (e.g., scheduling), component management, networking, security settings, and so on. The services 922 may provide other common services for the other software layers. The drivers 924 may be responsible for controlling and/or interfacing with the underlying hardware. For instance, the drivers 924 may include display drivers, camera drivers, Bluetooth® drivers, flash memory drivers, serial communication drivers (e.g., Universal Serial Bus (USB) drivers), Wi-Fi® drivers, audio drivers, power management drivers, and so forth.

The libraries 904 may provide a low-level common infrastructure that may be utilized by the applications 908. The libraries 904 may include system libraries (e.g., C standard library) 930 that may provide functions such as memory allocation functions, string manipulation functions, mathematic functions, and the like. In addition, the libraries 904 may include API libraries 932 such as media libraries (e.g., libraries to support presentation and manipulation of various media formats, such as MPEG4, H.264, MP3, AAC, AMR, JPG, or PNG), graphics libraries (e.g., an OpenGL framework that may be used to render 2D and 3D in a graphic content on a display), database libraries (e.g., SQLite that may provide various relational database functions), web libraries (e.g., WebKit that may provide web browsing functionality), and the like. The libraries 904 may also include a wide variety of other libraries 934 to provide many other APIs to the applications 908.

The frameworks 906 may provide a high-level common infrastructure that may be utilized by the applications 908. For example, the frameworks 906 may provide various graphic user interface (GUI) functions, high-level resource management, high-level location services, and so forth. The frameworks 906 may provide a broad spectrum of other APIs that may be utilized by the applications 908, some of which may be specific to a particular operating system or platform.

The applications 908 include a home application 950, a contacts application 952, a browser application 954, a book reader application 956, a location application 958, a media application 960, a messaging application 962, a game application 964, and a broad assortment of other applications, such as a third party application 966. In a specific example, the third party application 966 (e.g., an application developed using the Android™ or iOS™ software development kit (SDK) by an entity other than the vendor of the particular platform) may be mobile software running on a mobile operating system such as iOS™, Android™, Windows® Phone, or other mobile operating systems. In this example, the third party application 966 may invoke the API calls 910 provided by the operating system 902 to facilitate functionality described herein:EXAMPLE MACHINE

### Architecture and Machine-Readable Medium

FIG. 10 is a block diagram illustrating components of a machine 1000, according to some example embodiments, able to read instructions from a machine-readable medium (e.g., a machine-readable storage medium) and perform any one or more of the methodologies discussed herein. Specifically, FIG. 10 shows a diagrammatic representation of the machine 1000 in the example form of a computer system, within which instructions 1016 (e.g., software, a program, an application, an applet, an app, or other executable code) for causing the machine 1000 to perform any one or more of the methodologies discussed herein may be executed. For example the instructions 1016 may cause the machine 1000 to execute the flow diagrams of FIGS. 6, 7, and 8A-8B. The instructions 1016 transform the general, non-programmed machine 1000 into a particular machine programmed to carry out the described and illustrated functions in the manner described. In alternative embodiments, the machine 1000 operates as a standalone device or may be coupled (e.g., networked) to other machines. In a networked deployment, the machine 1000 may operate in the capacity of a server machine or a client machine in a server-client network environment, or as a peer machine in a peer-to-peer (or distributed) network environment. The machine 1000 may comprise, but not be limited to, a server computer, a client computer, a personal computer (PC), a tablet computer, a laptop computer, a netbook, a set-top box (STB), a personal digital assistant (PDA), an entertainment media system, a cellular telephone, a smart phone, a mobile device, a wearable device (e.g., a smart watch), a smart home device (e.g., a smart appliance), other smart devices, a web appliance, a network router, a network switch, a network bridge, or any machine capable of executing the instructions 1016, sequentially or otherwise, that specify actions to be taken by machine 1000. Further, while only a single machine 1000 is illustrated, the term “machine” shall also be taken to include a collection of machines 1000 that individually or jointly execute the instructions 1016 to perform any one or more of the methodologies discussed herein.

The machine 1000 may include processors 1010, memory/storage 1030, and I/O components 1050, which may be configured to communicate with each other such as via a bus 1002. In an example embodiment, the processors 1010 (e.g., a Central Processing Unit (CPU), a Reduced Instruction Set Computing (RISC) processor, a Complex Instruction Set Computing (CISC) processor, a Graphics Processing Unit (GPU), a Digital Signal Processor (DSP), an Application Specific Integrated Circuit (ASIC), a Radio-Frequency Integrated Circuit (RFIC), another processor, or any suitable combination thereof) may include, for example, processor 1012 and processor 1014 that may execute instructions 1016. The term “processor” is intended to include multi-core processor that may comprise two or more independent processors (sometimes referred to as “cores”) that may execute instructions 1016 contemporaneously. Although FIG. 10 shows multiple processors 1010, the machine 1000 may include a single processor with a single core, a single processor with multiple cores (e.g., a multi-core process), multiple processors with a single core, multiple processors with multiples cores, or any combination thereof.

The memory/storage 1030 may include a memory 1032, such as a main memory, or other memory storage, and a storage unit 1036, both accessible to the processors 1010 such as via the bus 1002. The storage unit 1036 and memory 1032 store the instructions 1016 embodying any one or more of the methodologies or functions described herein. The instructions 1016 may also reside, completely or partially, within the memory 1032, within the storage unit 1036, within at least one of the processors 1010 (e.g., within the processor's cache memory), or any suitable combination thereof, during execution thereof by the machine 1000. Accordingly, the memory 1032, the storage unit 1036, and the memory of processors 1010 are examples of machine-readable media.

As used herein, “machine-readable medium” means a device able to store instructions and data temporarily or permanently and may include, but is not be limited to, random-access memory (RAM), read-only memory (ROM), buffer memory, flash memory, optical media, magnetic media, cache memory, other types of storage (e.g., Erasable Programmable Read-Only Memory (EEPROM)) and/or any suitable combination thereof The term “machine-readable medium” should be taken to include a single medium or multiple media (e.g., a centralized or distributed database, or associated caches and servers) able to store instructions 1016. The term “machine-readable medium” shall also be taken to include any medium, or combination of multiple media, that is capable of storing instructions (e.g., instructions 1016) for execution by a machine (e.g., machine 1000), such that the instructions, when executed by one or more processors of the machine 1000 (e.g., processors 1010), cause the machine 1000 to perform any one or more of the methodologies described herein. Accordingly, a “machine-readable medium” refers to a single storage apparatus or device, as well as “cloud-based” storage systems or storage networks that include multiple storage apparatus or devices. The term “machine-readable medium” excludes signals per se.

The I/O components 1050 may include a wide variety of components to receive input, provide output, produce output, transmit information, exchange information, capture measurements, and so on. The specific I/O components 1050 that are included in a particular machine will depend on the type of machine. For example, portable machines such as mobile phones will likely include a touch input device or other such input mechanisms, while a headless server machine will likely not include such a touch input device. It will be appreciated that the I/O components 1050 may include many other components that are not shown in FIG. 10. The I/O components 1050 are grouped according to functionality merely for simplifying the following discussion and the grouping is in no way limiting. In various example embodiments, the 1/0 components 1050 may include output components 1052 and input components 1054. The output components 1052 may include visual components (e.g., a display such as a plasma display panel (PDP), a light emitting diode (LED) display, a liquid crystal display (LCD), a projector, or a cathode ray tube (CRT)), acoustic components (e.g., speakers), haptic components (e.g., a vibratory motor, resistance mechanisms), other signal generators, and so forth. The input components 1054 may include alphanumeric input components (e.g., a keyboard, a touch screen configured to receive alphanumeric input, a photo-optical keyboard, or other alphanumeric input components), point based input components (e.g., a mouse, a touchpad, a trackball, a joystick, a motion sensor, or other pointing instrument), tactile input components (e.g., a physical button, a touch screen that provides location and/or force of touches or touch gestures, or other tactile input components), audio input components (e.g., a microphone), and the like.

In further example embodiments, the I/O components 1050 may include biometric components 1056, motion components 1058, environmental components 1060, or position components 1062 among a wide array of other components. For example, the biometric components 1056 may include components to detect expressions (e.g., hand expressions, facial expressions, vocal expressions, body gestures, or eye tracking), measure biosignals (e.g., blood pressure, heart rate, body temperature, perspiration, or brain waves), identify a person (e.g., voice identification, retinal identification, facial identification, fingerprint identification, or electroencephalogram based identification), and the like. The motion components 1058 may include acceleration sensor components (e.g., accelerometer), gravitation sensor components, rotation sensor components (e.g., gyroscope), and so forth. The environmental components 1060 may include, for example, illumination sensor components (e.g., photometer), temperature sensor components (e.g., one or more thermometer that detect ambient temperature), humidity sensor components, pressure sensor components (e.g., barometer), acoustic sensor components (e.g., one or more microphones that detect background noise), proximity sensor components (e.g., infrared sensors that detect nearby objects), gas sensors (e.g., gas detection sensors to detection concentrations of hazardous gases for safety or to measure pollutants in the atmosphere), or other components that may provide indications, measurements, or signals corresponding to a surrounding physical environment. The position components 1062 may include location sensor components (e.g., a Global Position System (GPS) receiver component), altitude sensor components (e.g., altimeters or barometers that detect air pressure from which altitude may be derived), orientation sensor components (e.g., magnetometers and the like.

Communication may be implemented using a wide variety of technologies. The 1/0 components 1050 may include communication components 1064 operable to couple the machine 1000 to a network 1080 or devices 1070 via coupling 1082 and coupling 1072 respectively. For example, the communication components 1064 may include a network interface component or other suitable device to interface with the network 1080. In further examples, communication components 1064 may include wired communication components, wireless communication components, cellular communication components, Near Field Communication (NFC) components, Bluetooth® components (e.g., Bluetooth® Low Energy), Wi-Fi® components, and other communication components to provide communication via other modalities. The devices 1070 may be another machine or any of a wide variety of peripheral devices (e.g., a peripheral device coupled via a Universal Serial Bus (USB)).

Moreover, the communication components 1064 may detect identifiers or include components operable to detect identifiers. For example, the communication components 1064 may include Radio Frequency Identification (RFID) tag reader components, NFC smart tag detection components, optical reader components (e.g., an optical sensor to detect one-dimensional bar codes such as Universal Product Code (UPC) bar code, multi-dimensional bar codes such as Quick Response (QR) code, Aztec code, Data Matrix, Dataglyph, MaxiCode, PDF417, Ultra Code, UCC RSS-2D bar code, and other optical codes), or acoustic detection components (e.g., microphones to identify tagged audio signals). In addition, a variety of information may be derived via the communication components 1064, such as, location via Internet Protocol (IP) geo-location, location via Wi-Fi® signal triangulation, location via detecting an NEC beacon signal that may indicate a particular location, and so forth.

### Transmission Medium

In various example embodiments, one or more portions of the network 1080 may be an ad hoc network, an intranet, an extranet, a virtual private network (VPN), a local area network (LAN), a wireless LAN (WLAN), a wide area network (WAN), a wireless WAN (WWAN), a metropolitan area network (MAN), the Internet, a portion of the Internet, a portion of the Public Switched Telephone Network (PSTN), a plain old telephone service (POTS) network, a cellular telephone network, a wireless network, a Wi-Fi® network, another type of network, or a combination of two or more such networks. For example, the network 1080 or a portion of the network 1080 may include a wireless or cellular network and the coupling 1082 may be a Code Division Multiple Access (CDMA) connection, a Global System for Mobile communications (GSM) connection, or other type of cellular or wireless coupling. In this example, the coupling 1082 may implement any of a variety of types of data transfer technology, such as Single Carrier Radio Transmission Technology (1× RTT), Evolution-Data Optimized (EVDO) technology, General Packet Radio Service (GPRS) technology, Enhanced Data rates for GSM Evolution (EDGE) technology, third Generation Partnership Project (3GPP) including 3G, fourth generation wireless (4G) networks, Universal Mobile Telecommunications System (UMT'S), High Speed Packet Access (HSPA), Worldwide Interoperability for Microwave Access (WiMAX), Long Term Evolution (LTE) standard, others defined by various standard setting organizations, other long range protocols, or other data transfer technology.

The instructions 1016 may be transmitted or received over the network 1080 using a transmission medium via a network interface device (e.g., a network interface component included in the communication components 1064) and utilizing any one of a number of well-known transfer protocols (e.g., hypertext transfer protocol (HTTP)). Similarly, the instructions 1016 may be transmitted or received using a transmission medium via the coupling 1072 (e.g., a peer-to-peer coupling) to devices 1070. The term “transmission medium” shall be taken to include any intangible medium that is capable of storing, encoding, or carrying instructions 1016 for execution by the machine 1000, and includes digital or analog communications signals or other intangible medium to facilitate communication of such software.

### Language

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein.

Although an overview of the inventive subject matter has been described with reference to specific example embodiments, various modifications and changes may be made to these embodiments without departing from the broader scope of embodiments of the present disclosure. Such embodiments of the inventive subject matter may be referred to herein, individually or collectively, by the term “invention” merely for convenience and without intending to voluntarily limit the scope of this application to any single disclosure or inventive concept if more than one is, in fact, disclosed.

The embodiments illustrated herein are described in sufficient detail to enable those skilled in the art to practice the teachings disclosed. Other embodiments may be used and derived therefrom, such that structural and logical substitutions and changes may be made without departing from the scope of this disclosure. The Detailed Description, therefore, is not to be taken in a limiting sense, and the scope of various embodiments is defined only by the appended claims, along with the full range of equivalents to which such claims are entitled.

As used herein, the term “or” may be construed in either an inclusive or exclusive sense. Moreover, plural instances may be provided for resources, operations, or structures described herein as a single instance. Additionally, boundaries between various resources, operations, modules, engines, and data stores are somewhat arbitrary, and particular operations are illustrated in a context of specific illustrative configurations. Other allocations of functionality are envisioned and may fall within a scope of various embodiments of the present disclosure. In general, structures and functionality presented as separate resources in the example configurations may be implemented as a combined structure or resource. Similarly, structures and functionality presented as a single resource may be implemented as separate resources. These and other variations, modifications, additions, and improvements fall within a scope of embodiments of the present disclosure as represented by the appended claims. The specification and drawings are, accordingly, to be regarded in an illustrative rather than a restrictive sense.

What is claimed is:

1. A method comprising:
at a frame device including one or more processors and memory storing one or more programs for execution by the one or more processors, wherein the frame device includes a display:
receiving, from a central server, media content item data;
determining, using the one or more processors of the frame device, whether the user preferences stored at the frame device allow a media content item associated with the received media content item to be presented;
converting the received media content item data from a first data format to a second data format, wherein the first data format is associated with the central server and the second data format is associated with the display at the frame device; and
presenting, on the display, the media content item associated with the received media content item data.

2. The method of claim 1, wherein the media content item data is received from the central server in response to a request from a first user.

3. The method of claim 1, wherein the media content item data is received from the central server in response to a request from a second user not associated with the frame device.

4. The method of claim 3, wherein the frame device is associated with a first user and determining whether the user preferences stored at the framed device allow a media content item associated with the received media content item to be presented further comprises:
determining whether the second user has permission to initiate presentation of a media content item at the frame device.

5. The method of claim 4, wherein determining whether the second user has permission to initiate presentation of a media content item at the frame device further comprises:
determining whether the second user is connected to the first user through a social network associated with the central server;
in accordance with a determination that the second user is connected to the first user through a social network associated with the central server, determining a degree of connection between the first user and the second user; and
in accordance with a determination that the degree of connection between the first user and the second user is with within a predefined threshold, determining that the second user has permission to initiate presentation of a media content item at the frame device.

6. The method of claim 1, wherein the media content item data is received from the central server based on a popularity rating from other users of the central server.

7. The method of claim 6, wherein the popularity rating is based only on users that are connected to a first user associated with the frame device.

8. The method of claim 1, wherein the media content item data is associated with a collection of media content items, and the media content item data includes media content item layout data.

9. The method of claim 8, further comprising determining whether a plurality of frame devices are available to display media content items in the collection of media content items.

10. The method of claim 9, further comprising:
in accordance with a determination that a plurality of frame devices are available to display media content items in the collection of media content items, accessing relative location data for each of the frame devices.

11. The method of claim 10, further comprising:
mapping one or more media content items from the collection of media content item to each of the plurality of frame devices based on the media content item layout data and the relative location data for each of the frame devices.

12. The method of claim 1, wherein the frame device is an e-paper display.

13. A frame device comprising:
one or more computer processors; and
one or computer-readable mediums storing instructions that, when executed by the one or more computer processors, cause the frame device to perform operations comprising:
receiving, from a central server, media content item data;
determining whether the user preferences stored at the frame device allow a media content item associated with the received media content item to be presented;
converting the received media content item data from a first data format to a second data format, wherein the first data format is associated with the central server and the second data format is associated with the display at the frame device; and
presenting, on a display, the media content associated with the received media content item data.

14. The frame device of claim 13, wherein the media content item data is received from the central server in response to a request from a first user.

15. The frame device of claim 12, wherein the media content item data is received from the central server in response to a request from a second user not associated with the frame device.

16. The frame device of claim 15, wherein the frame device is associated with a first user and determining whether the user preferences stored at the framed device allow a media content item associated with the received media content item to be presented further comprises:
determining whether the second user has permission to initiate presentation of a media content item at the frame device.

17. The frame device of claim 16, wherein determining whether the second user has permission to initiate presentation of a media content item at the frame device further comprises:
determining whether the second user is connected to the first user through a social network associated with the central server;
in accordance with a determination that the second user is connected to the first user through a social network associated with the central server, determining a degree of connection between the first user and the second user; and
in accordance with a determination that the degree of connection between the first user and the second user is with within a predefined threshold, determining that the second user has permission to initiate presentation of a media content item at the frame device.

18. The frame device of claim 12, wherein the media content item data is received from the central server based on a popularity rating from other users of the central server.

19. The frame device of claim 8, wherein the popularity rating is based only on users that are connected to a first user associated with the frame device.

20. A non-transitory computer-readable medium storing instructions that, when executed by one or more computer processors of a frame device, cause the frame device to perform operations comprising:
receiving, from a central server, media content item data;
determining whether the user preferences stored at the frame device allow a media content item associated with the received media content item to be presented;
converting the received media content item data from a first data format to a second data format, wherein the first data format is associated with the central server and the second data format is associated with the display at the frame device; and
presenting, on a display, the media content item associated with the received media content item data.
